(19) United States
(12) Patent Application Publication
(10) Pub. No.: US 2006/0071758 A1
(43) Pub. Date: Apr. 6, 2006

(54) Adaptively adjusting a query parameter Q used for inventorying RFID tags

(75) Inventors: Scott Anthony Cooper, Seattle, WA (US); Christopher J. Diorio, Shoreline, WA (US); Todd E. Humes, Shoreline, WA (US); Vadim Pavlovich Lobanov, Seattle, WA (US)

Correspondence Address: MERCHANT & GOULD PC, P.O. BOX 2903, MINNEAPOLIS, MN, 55402-0903, US

(73) Assignee: IMPINJ, Inc., Seattle, WA (US)

(21) Appl. No.: 11/210,422

(22) Filed: Aug. 24, 2005

Related U.S. Application Data
(63) Continuation-in-part of application No. 11/031,459, filed on Jan. 7, 2005.
(60) Provisional application No. 60/656,299, filed on Feb. 24, 2005.

(51) Int. Cl. H04Q 5/22

(52) U.S. Cl. 340/10.2

(57) ABSTRACT

RFID system components, such as readers and tags, communicate where the reader inventories a population of tags. The reader evaluates responses from tags by categorizing them in slots. As tags are inventoried, the number of slots based on a Q-parameter is reduced. The reader determines an interim value for the Q parameter, generates a Q1 value by applying the interim value to a damping function, and uses the Q1 value in another round of interrogation. The reader then determines whether to increase or decrease the interim value depending on the tag replies. The increase or decrease may be an increment or a decrement such as incrementing or decrementing a floating point number of the interim value in a damping function that is arranged to return an integer by rounding the floating point number.

### RELATED APPLICATIONS

This utility patent application claims the benefit of U.S. Provisional Application Ser. No. 60/656,299 filed on Feb. 24, 2005, which is hereby claimed under 35 U.S.C. §119(e). Furthermore, this application is a continuation-in-part (CIP) of U.S. patent application Ser. No. 11/031,459 (IMPJ-0100) filed on Jan. 7, 2005. The benefit of the earlier filing date of the parent application is hereby claimed under 35 U.S.C. §120. The referenced Provisional Application and the parent Utility Application are incorporated herein by reference.

This application may be found to be related to the following applications, all of which are incorporated herein by reference:
Application titled “INVENTORYING RFID TAGS BY EMPLOYING A QUERY PARAMETER Q THAT CONVERGES HEURISTICALLY”, by inventors Christopher J. Diorio, Todd E. Humes, Scott A. Cooper, Vadim P. Lobanov, filed with the USPTO on the same day as the present application, and due to be assigned to the same assignee (Attorney docket # 50133.19USU4/IMPJ-0153);
Application titled “INVENTORYING RFID TAGS BY EMPLOYING A QUERY PARAMETER Q THAT IS ADJUSTED FOR IMPROVING”, by inventors Todd E. Humes, Christopher J. Diorio, Scott A. Cooper, Vadim P. Lobanov, filed with the USPTO on the same day as the present application, and due to be assigned to the same assignee (Attorney docket # 50133.19USU1/IMPJ-0140);
Application titled “CHANGING MANNER OF DETERMINING A QUERY PARAMETER Q USED FOR INVENTORYING RFID TAGS”, by inventors Scott A. Cooper, Christopher J. Diorio, Todd E. Humes, Vadim P. Lobanov, filed with the USPTO on the same day as the present application, and due to be assigned to the same assignee (Attorney docket # 50133.19USU2/IMPJ-0141); and
Application titled “STORING AND RETRIEVING A QUERY PARAMETER Q USED FOR INVENTORYING RFID TAGS”, by inventors Vadim P. Lobanov, Christopher J. Diorio, Todd E. Humes, Scott A. Cooper, filed with the USPTO on the same day as the present application, and due to be assigned to the same assignee (Attorney docket # 50133.19USU3/IMPJ-0152).

### TECHNICAL FIELD

The present invention relates to Radio Frequency IDentification (RFID) tags and readers, and more particularly, to methods and apparatus for inventorying of a tag population.

### BACKGROUND

Radio Frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included a power storage device, such as a battery. RFID tags with a power storage device are known as active tags. Advances in semiconductor technology have miniaturized the electronics so much that an RFID tag can be powered solely by the RF signal it receives. Such RFID tags do not include a power storage device, and are called passive tags.

### SUMMARY

The disclosure teaches how to facilitate communication between an RFID reader and a population of RFID tags, in particular inventorying of the tags within a population where the number of the tags is not known initially.

In some embodiments, the tags choose randomly one of a plurality of slots in response to a communicated value of a Q parameter by the readers and reply according to their chosen slot. The reader determines an interim value for the Q parameter, generates a Q1 value by applying the interim value to a damping function, and addresses the tags by communicating a Q1 value for the Q parameter and generates first contents with replies from the tags as resulting from communicating the Q1 value. The reader then determines whether to decrease the interim value depending on the first contents.

If the interim value is to be decreased, the reader subtracts a decrement from the interim value, generates a Q2 value by applying the decremented interim value to the damping function, and addresses a portion of the tags by communicating the Q2 value for the Q parameter.

In one embodiment, the interim value may be a floating point number and the damping function arranged to return an integer by rounding the floating point number. In another embodiment, the decrement may be adapted such as a function of one of the interim value and the Q1 value.

In further embodiments, the reader may add an increment to the interim value, if it determines not to decrement the interim value. This may be accomplished by generating a Q3 value by applying the incremented interim value to the damping function and addressing a portion of the tags by communicating the Q3 value for the Q parameter.

While example embodiments are shown using a particular number of RFID tags and reader configurations, the principles disclosed herein may be implemented with fewer or more tags as well as other reader configurations. Thus, the disclosure is not limited to the illustrated examples. Moreover, the tags communicating with the RFID readers may be active or passive tags.

### BRIEF DESCRIPTION OF THE DRAWINGS

Non-limiting and non-exhaustive embodiments are described with reference to the following drawings.

FIG. 1 illustrates an RFID system including an RFID reader and an RFID tag;

FIG. 2 is a diagram of an RFID tag such as the RFID tag shown in FIG. 1;

FIG. 3 illustrates an embodiment of a block diagram for an electrical circuit that may be employed in an RFID tag such as the RFID tag of FIG. 2;

FIGS. 4A and 4B illustrate two versions of the electrical circuit of FIG. 3 emphasizing signal flow in receive and transmit operational modes, respectively;

FIGS. 5A and 5B illustrate two possible embodiments of major functional blocks of an RFID reader such as the RFID reader shown in FIG. 1;

FIG. 6 is a conceptual diagram for explaining a half-duplex mode of communication between the components of the RFID system of FIG. 1, during operation;

FIG. 7A is a time diagram illustrating different events of numbers of tags entering and exiting a field of view of an RFID reader;

FIG. 7B is a time diagram illustrating the inventory problem facing an RFID reader experiencing the events of FIG. 7A;

FIG. 8 illustrates an RFID system including an RFID reader communicating during an event with a plurality of RFID tags that are in its field of view;

FIG. 9 is an action table illustrating actions for the RFID reader of FIG. 8 to singulate the RFID tags of FIG. 8 during inventory rounds;

FIG. 10 illustrates the RFID system of FIG. 8, where one of the tags that has been singulated during an action of FIG. 9, is being accessed and inventoried;

FIG. 11A is a diagram illustrating an example of tags filling their slot counters by Random Number Generators, in response to commands by an RFID reader;

FIG. 11B is a diagram illustrating how the numbers stored in the slot counters of FIG. 11A result in randomly chosen slots that arrange the RFID tags in an order to be accessed by an RFID reader;

FIGS. 12A, 12B, and 12C are diagrams illustrating the result of sequentially decrementing the numbers stored in the slot counters of the RFID tags of FIG. 11B, and replying when it becomes zero;

FIG. 13A is a flowchart illustrating a method that is used to inventory tags by freely permitting a value of Q to increase and decrease freely;

FIG. 13B is a time diagram showing example replies received according to a box of the flowchart of FIG. 13A;

FIG. 13C is a diagram of classifying the replies received in the time diagram of FIG. 13B in buckets according to another box of the flowchart of FIG. 13A;

FIG. 13D is another action table, illustrating additional commands available to change quickly the value of Q by communicating only the increments and decrements according to the method of FIG. 13A;

FIG. 13E is an example time diagram illustrating the value of Q varying according to the method of FIG. 13A, along with the resulting number of tags that remain to be inventoried;

FIG. 14A is a flowchart illustrating a method, according to one embodiment, that can be used to inventory tags by adjusting a value of Q such that a performance converges;

FIG. 14B is a diagram illustrating heuristically trying various values for Q with a view to optimize a presumed merit function according to one embodiment;

FIG. 14C is a diagram illustrating preventing Q from changing quickly if it has reached a value that is close to a longer term optimized Q value according to another embodiment;

FIG. 14D is an action table, reflecting commands that change the value of Q relatively less often according to the method of FIG. 14A;

FIG. 14E is an example time diagram illustrating the value of Q varying according to the method of FIG. 14A, along with the resulting number of tags that remain to be inventoried;

FIG. 15 illustrates an example computation of a probability of replies from RFID tags to an initial query by an RFID reader;

FIG. 16 illustrates probability plots of various replies according to the computation of FIG. 15;

FIG. 17 illustrates one of the plots of FIG. 16 as a merit function, and further includes an optional fairway around an optimum point, and corrections to Q values for various operating points, so that overall performance enters the fairway;

FIG. 18A is a flowchart illustrating a method that can be used to inventory tags by adjusting a value of Q such that a performance enters a fairway according to one embodiment;

FIG. 18B is a time diagram illustrating contents for slots generated from tag replies of FIG. 11A, after the tags have been queried up to approximately the stage of FIG. 12A, according to a box of the flowchart of FIG. 18A, along with the unknown contents that have yet to be received;

FIG. 18C illustrates processing the categorized contents of FIG. 18B according to another box of the flowchart of FIG. 18A;

FIG. 18D is a diagram repeating the plot of FIG. 17, identifying an operating point according to the processed contents of FIG. 18C, and determining a value of a new Q for a performance to enter the fairway;

FIG. 18E is a diagram illustrating an example of the tags of FIG. 11A after filling again their slot counters by Random Number Generators, in response to commands by an RFID reader communicating an updated Q learned from considering FIG. 18D;

FIG. 18F is a diagram illustrating how the tags of FIG. 18E have been redistributed in a way that is more advantageous than that of FIG. 11B;

FIG. 18G is an example time diagram illustrating the value of Q varying according to the method of FIG. 18A, along with the resulting number of tags that remain to be inventoried;

FIG. 19 is a flowchart illustrating a method that can be used to inventory tags by changing a manner of how a value of Q is determined, so that an overall performance can be optimized according to embodiments;

FIG. 20 is a conceptual diagram illustrating the manner change of FIG. 19 being implemented by providing a choice between distinct algorithms, according to an embodiment;

FIG. 21 is a conceptual diagram illustrating the manner change of FIG. 19 being implemented by providing a choice between distinct subroutines of an algorithm, according to an embodiment;

FIG. 22 is a conceptual diagram illustrating the manner change of FIG. 19 being implemented by providing a choice of selecting a value of a controlling variable, according to an embodiment;

FIG. 23 is a diagram illustrating an optimization of Q using two different manners for determining Q;

FIG. 24 is a diagram illustrating an example optimization of Q using two distinctly different damping parameter values;

FIG. 25 is a flowchart illustrating an example of a method of changing a value of Q by adaptively adjusting Q;

FIG. 26 is an example simulation diagram illustrating converging of Q by using a damping algorithm;

FIGS. 27A and 27B are diagrams illustrating retrieval and storage of a parameter used to determine an initial value of Q;

FIG. 28 is a flowchart illustrating an embodiment of a method of using an initial value of Q based on a previously stored parameter; and

FIG. 29 is an example simulation diagram illustrating converging of Q, where Q starts from a known value.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for the terms. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected or an indirect connection through one or more passive or active intermediary devices. The term “circuit” means either a single component or a multiplicity of components, either active and/or passive, that are coupled together to provide a desired function. The term “signal” means at least one current, voltage, charge, temperature, data, or other measurable quantity. The term 2ˆQ means two to the power of Q. The terms RFID tag and RFID reader are used interchangeably with the terms tag and reader, respectively.

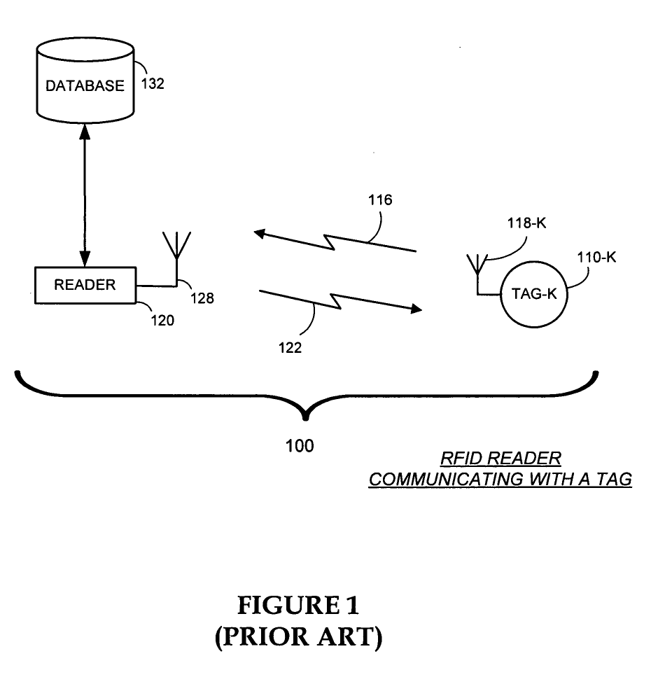

FIG. 1 is a diagram of a typical RFID system 100, incorporating aspects of the invention. An RFID reader 120 transmits an interrogating Radio Frequency (RF) wave 122. RFID tag 110-K in the vicinity of RFID reader 120 may sense interrogating RF wave 122, and generate wave 116 in response. RFID reader 120 senses and interprets wave 116.

Reader 120 and tag 110-K exchange data via wave 122 and wave 116. In a session of such an exchange, each encodes, modulates, and transmits data to the other, and each receives, demodulates, and decodes data from the other. The data is modulated onto, and decoded from, RF waveforms, as will be seen in more detail below.

Encoding the data can be performed in a number of different ways. For example, protocols are devised to communicate in terms of symbols, also called RFID symbols. A symbol for communicating can be a preamble, a null symbol, and so on. Further symbols can be implemented for exchanging binary data, such as “0” and “1”.

Tag 110-K can be a passive tag or an active tag, i.e. having its own power source. Where tag 110-K is a passive tag, it is powered from wave 122.

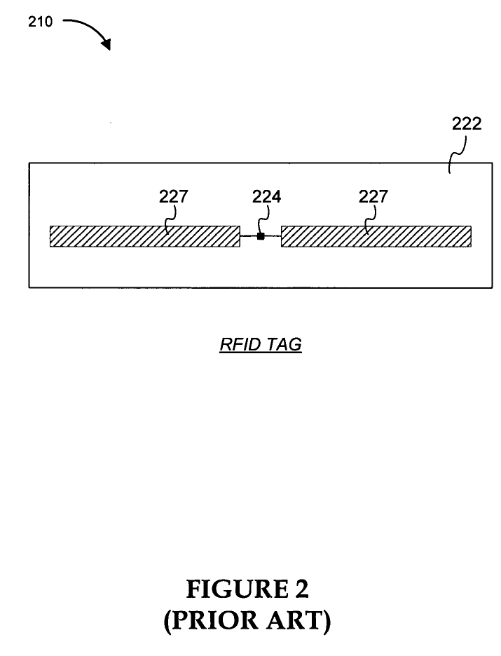

FIG. 2 is a diagram of RFID tag 210. Tag 210 is implemented as a passive tag, meaning it does not have its own power source. Much of what is described in this document, however, applies also to active tags.

Tag 210 is formed on a substantially planar inlay 222, which can be made in many ways known in the art. Tag 210 also includes two antenna segments 227, which are usually flat and attached to inlay 222. Antenna segments 227 are shown here forming a dipole, but many other embodiments using any number of antenna segments are possible.

Tag 210 also includes an electrical circuit, which is preferably implemented in an integrated circuit (IC) 224. IC 224 is also arranged on inlay 222, and electrically coupled to antenna segments 227. Only one method of coupling is shown, while many are possible.

In operation, a signal is received by antenna segments 227, and communicated to IC 224. IC 224 both harvests power, and decides how to reply, if at all. If it has decided to reply, IC 224 modulates the reflectance of antenna segments 227, which generates the backscatter from a wave transmitted by the reader. Coupling together and uncoupling antenna segments 227 can modulate the reflectance, as can a variety of other means.

In the embodiment of FIG. 2, antenna segments 227 are separate from IC 224. In other embodiments, antenna segments may alternately be formed on IC 224, and so on.

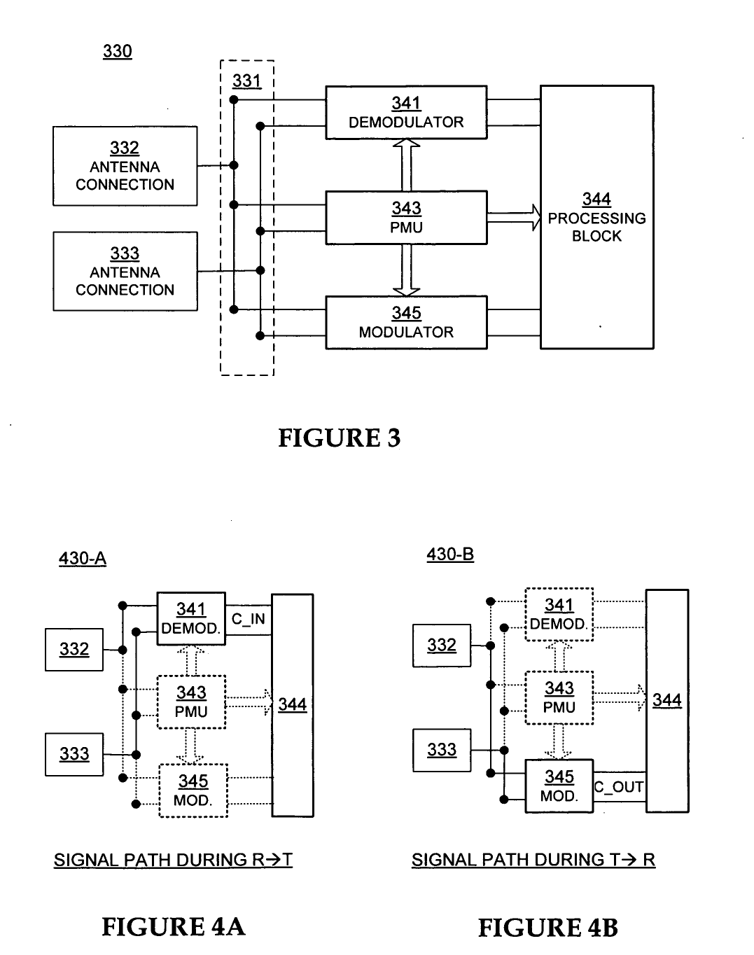

FIG. 3 is a block diagram of an electrical circuit 330. Circuit 330 may be formed in an IC of an RFID tag, such as IC 224 of FIG. 2. Circuit 330 has a number of main components that are described in this document. Circuit 330 may have a number of additional components from what is shown and described, or different components, depending on the exact implementation.

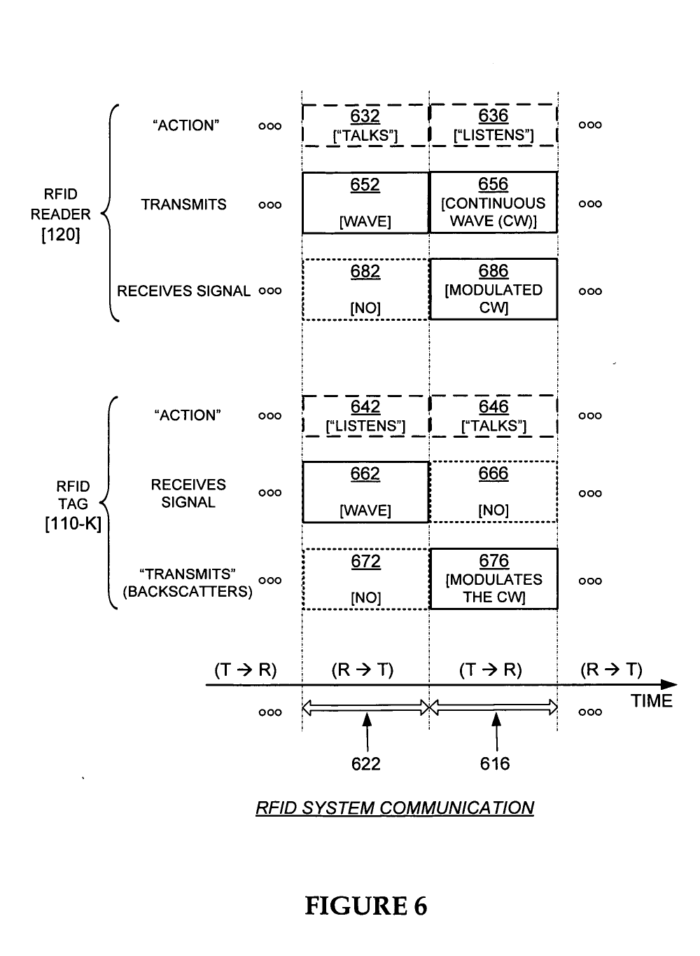

Circuit 330 includes at least two antenna connections 332, 333, which are suitable for coupling to antenna segments (not shown in FIG. 6). Antenna connections 332, 333 may be made in any suitable way, such as pads and so on. In a number of embodiments more antenna connections are used, especially in embodiments where more antenna segments are used.

Circuit 330 includes a section 331. Section 331 may be implemented as shown, for example as a group of nodes for proper routing of signals. In some embodiments, section 331 may be implemented otherwise, for example to include a receive/transmit switch that can route a signal, and so on.

Circuit 330 also includes a Power Management Unit (PMU) 343. PMU 343 may be implemented in any way known in the art, for harvesting raw RF power received via antenna connections 332, 333. In some embodiments, PMU 343 includes at least one rectifier, and so on.

In operation, an RF wave received via antenna connections 332, 333 is received by PMU 343, which in turn generates power for components of circuit 330. This is true for either or both of R→T sessions (when the received RF wave carries a signal) and T→R sessions (when the received RF wave carries no signal).

Circuit 330 additionally includes a demodulator 341. Demodulator 341 demodulates an RF signal received via antenna connections 332, 333. Demodulator 341 may be implemented in any way known in the art, for example including an attenuator stage, amplifier stage, and so on.

Circuit 330 further includes a processing block 344. Processing block 344 receives the demodulated signal from demodulator 341, and may perform operations. In addition, it may generate an output signal for transmission.

Processing block 344 may be implemented in any way known in the art. For example, processing block 344 may include a number of components, such as a processor, a memory, a decoder, an encoder, and so on.

Circuit 330 additionally includes a modulator 345. Modulator 345 modulates an output signal generated by processing block 344. The modulated signal is transmitted by driving antenna connections 332, 333, and therefore driving the load presented by the coupled antenna segments. Modulator 345 may be implemented in any way known in the art, for example including a driver stage, amplifier stage, and so on.

In one embodiment, demodulator 341 and modulator 345 may be combined in a single transceiver circuit. In another embodiment, modulator 345 may include a backscatter transmitter or an active transmitter.

FIG. 4A shows version 430-A of circuit 330 of FIG. 3. Version 430-A shows the components of circuit 330 for a tag, further modified to emphasize a signal operation during a R→T session (receive mode of operation) during time interval 622 of FIG. 6. An RF wave is received from antenna connections 332, 333, a signal is demodulated from demodulator 341, and then input to processing block 344 as C_IN. In one embodiment according to the present invention, C_IN may include a received stream of symbols.

Version 430-A shows as relatively obscured those components that do not play a part in processing a signal during a R→T session. Indeed, PMU 343 may be active, but only in converting raw RF power. And modulator 345 generally does not transmit during a R→T session. Modulator 345 typically does not interact with the received RF wave significantly, either because switching action in section 335 of FIG. 4 decouples the modulator 345 from the RF wave, or by designing modulator 345 to have a suitable impedance, and so on.

While modulator 345 is typically inactive during a R→T session, it need not be always the case. For example, during a R→T session, modulator 345 could be active in other ways. For example, it could be adjusting its own parameters for operation in a future session.

FIG. 4B shows version 430-B of circuit 330 of FIG. 3. Version 430-B shows the components of circuit 330 for a tag, further modified to emphasize a signal operation during a T→R session during time interval 616 of FIG. 6. A signal is output from processing block 344 as C_OUT. In one embodiment, C_OUT may include a transmission stream of symbols. C_OUT is then modulated by modulator 345, and output as an RF wave via antenna connections 332, 333.

Version 430-B shows as relatively obscured those components that do not play a part in processing a signal during a T→R session. Indeed, PMU 441 may be active, but only in converting raw RF power. And demodulator 341 generally does not receive during a T→R session. Demodulator 341 typically does not interact with the transmitted RF wave, either because switching action in section 335 decouples the demodulator 341 from the RF wave, or by designing demodulator 341 to have a suitable impedance, and so on.

While demodulator 341 is typically inactive during a T→R session, it need not be always the case. For example, during a T→R session, demodulator 341 could be active in other ways. For example, it could be adjusting its own parameters for operation in a future session.

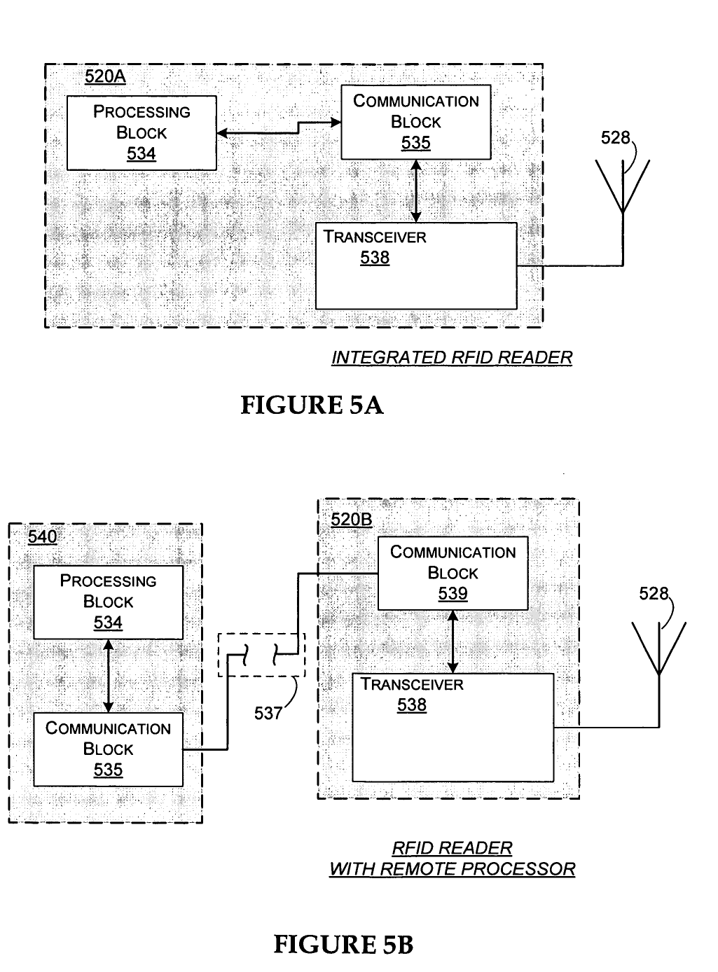

FIG. 5A illustrates major functional blocks of RFID reader 520A, which is one possible embodiment of the RFID reader 120 of FIG. 1. RFID reader 520A is typically coupled to an antenna such as antenna 528 and includes major functional blocks: processing block 534, communication block 535, and transceiver 538.

Transceiver 538 may include a modulator, a demodulator, and other circuitry as necessary. Transceiver 538 is arranged to modulate an RF wave based on one or more signals from communication block 535 and transmit via antenna 528 to RFID tags within a field view of RFID reader 520A.

Transceiver 538 is further arranged to demodulate an RF wave received from the RFID tags within its field of view and provide to processing block 534 through communication block 535. Transceiver 538 may be implemented in any way known in the art and include circuits such as mixers, amplifiers, filters, and the like.

Communication block 535 is arranged to provide communication between processing block 534 and transceiver 538, as well as any other circuits within RFID reader 520A. Communication block 535 may condition, filter, amplify, and digitally process signals between various circuits. In one embodiment, communication block 535 may also be employed in communicating with external devices through various connections including, but not limited to, Ethernet, RF link, infrared link, and the like.

RFID reader 520A further includes processing block 534. Processing block 534 may receive a demodulated signal from transceiver 538 and perform operations. In addition, it may generate an output signal for transmission.

Processing block 534 may be implemented in any way known in the art. For example, processing block 534 may include a number of components, such as a processor, a memory, a decoder, an encoder, and so on.

RFID reader 520A may include a further block including a power supply, an input/output module, and the like. RFID reader 520A may be powered from a wall outlet, a battery, and so on.

FIG. 5B illustrates major functional blocks of RFID reader 520B, which is another possible embodiment of the RFID reader 120 of FIG. 1. Parts of RFID reader 520B that are similarly numbered in RFID reader 520A of FIG. 5A are arranged to function in a likewise manner.

RFID reader 520B, differently from RFID reader 520A, does not include a processor block. Instead, RFID reader 520B includes transceiver 538 and communication block 539, along with the coupled antenna 528.

Processing block 534 and communication block 535 are housed in a different device designated by reference numeral 540. Communications between processing block 534 and transceiver 538 may be provided by communication blocks 535 and 539, which are coupled through communication link 537.

Communication link 537 may include any type of connection known in the art such as a phone line link, an Ethernet link, an RF link, an infrared link, and the like. For example, device 540 may be implemented as a network controller that is arranged to manage a number of RFID readers via wired and wireless links.

The components of the RFID system of FIG. 1 may communicate with each other in any number of modes. One such mode is called full duplex. Another such mode is called half-duplex, as described below.

FIG. 6 is a conceptual diagram 600 for explaining the half-duplex mode of communication between the components of the RFID system of FIG. 1, especially when tag 110-K is implemented as passive tag 210 of FIG. 2. The explanation is made with reference to a TIME axis, and also to a human metaphor of “talking” and “listening”. The actual technical implementations for “talking” and “listening” are now described.

RFID reader 120 and RFID tag 110-K talk and listen to each other by taking turns. As seen on axis TIME, when reader 120 talks to tag 110-K the session is designated as “R→T”, and when tag 110-K talks to reader 120 the session is designated as “T→R”. Along the TIME axis, a sample R→T session occurs during a time interval 622, and a following sample T→R session occurs during a time interval 616. Of course intervals 622, 616 can be of different durations—here the durations are shown approximately equal only for purposes of illustration.

According to blocks 632 and 636, RFID reader 120 talks during interval 622, and listens during interval 616. According to blocks 642 and 646, RFID tag 110-K listens while reader 120 talks (during interval 622), and talks while reader 120 listens (during interval 616).

In terms of actual technical behavior, during interval 622, reader 120 talks to tag 110-K as follows. According to block 652, reader 120 transmits wave 122, which was first described in FIG. 1. At the same time, according to block 662, tag 110-K receives wave 122 and processes it. Meanwhile, according to block 672, tag 110-K does not backscatter with its antenna, and according to block 682, reader 120 has no wave to receive from tag 110-K.

During interval 616, tag 110-K talks to reader 120 as follows. According to block 656, reader 120 transmits a Continuous Wave (CW), which can be thought of as a carrier signal that ideally encodes no information. As discussed before, this carrier signal serves both to be harvested by tag 110-K for its own internal power needs, and also as a wave that tag 110-K can backscatter. Indeed, during interval 616, according to block 666, tag 110-K does not receive a signal for processing. Instead, according to block 676, tag 110-K modulates the CW emitted according to block 656, so as to generate backscatter wave 116. Concurrently, according to block 686, reader 120 receives backscatter wave 116 and processes it.

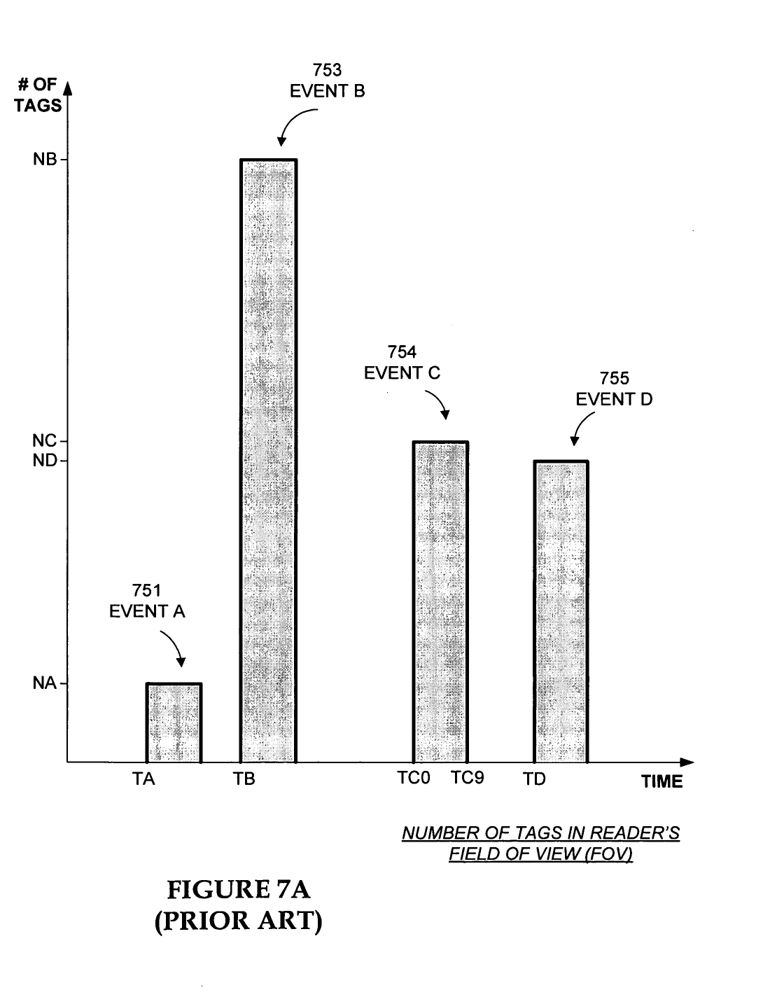

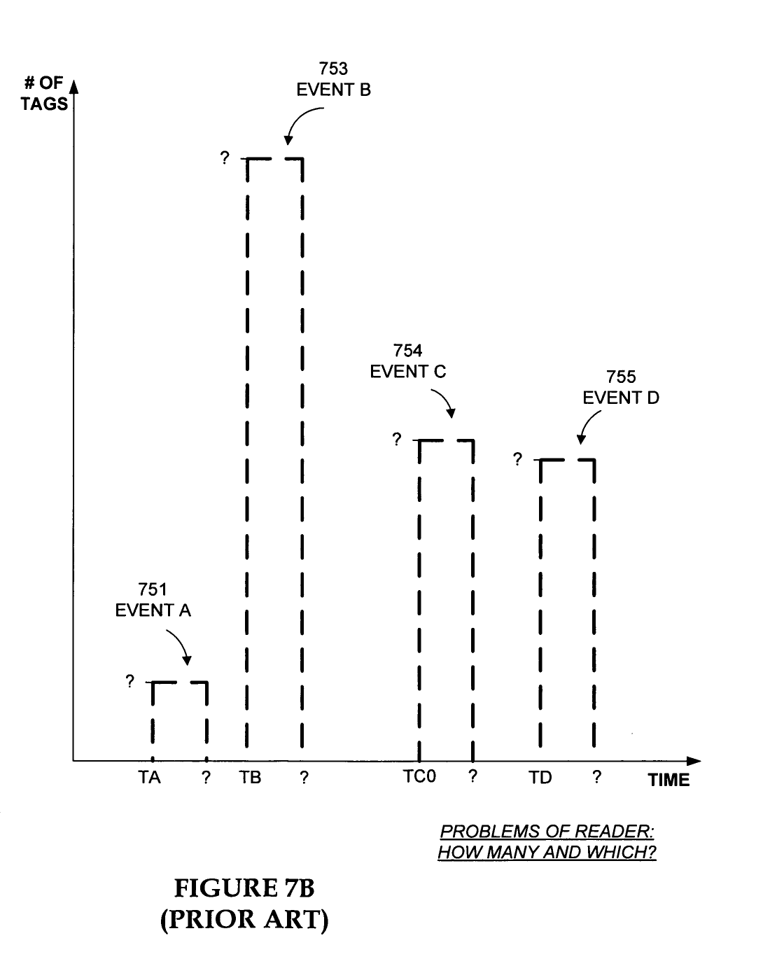

FIG. 7A is a time diagram illustrating different events of numbers of tags entering and exiting a field of view of an RFID reader such as RFID reader 120 of FIG. 1.

Communication between an RFID reader and RFID tags within its field of view may be categorized in a number of ways such as inventory, singulation, access, and the like. During each of these communications various commands and replies may be exchanged. Each exchange or group of exchanges may be defined as an event, and the number of tags within the field of view of the RFID reader may change during each event.

For example, an RFID reader may be positioned at the door of a warehouse and arranged to interrogate RFID tags on incoming and/or outgoing goods. Because the goods may be in motion while the RFID tags are being interrogated, some tags may drop out of the field of view, as new tags enter.

Other causes such as power level of RFID tags and physical obstructions within the field of view may also cause number tags corresponding with the RFID reader to change during an event.

Horizontal axis of the diagram represents time. Vertical axis represents number of tags in communication with the RFID reader. Each of the bars 751, 753, 754, and 755 represent the number of tags in communication with the RFID reader during each of the events A, B, C, and D, respectively.

As the diagram illustrates, the events need not be equidistant in time. Furthermore, the duration of each event may also be different. Events A, B, and D (751, 753, and 755) are indicated by their start times TA, TB, and TD, respectively. Event C (754) is indicated by the start and end times TC0 and TC9.

FIG. 7B is a time diagram illustrating the inventory problem facing an RFID reader experiencing the events of FIG. 7A.

This scenario could occur, for example, near a dock door of a warehouse or distribution center. For each event an unknown number of tags may enter or exit the field of view of the RFID reader as described above. Moreover, end times of each of the events A, B, C, and D may not be determined when each of the events begin.

Depending on the type of event such as inventorying of the tags, changing of states of the tags within the field of view, and the like, the reader may need to determine the number of tags its communicating with.

For each event, the reader may first determine the number of tags and perform the actions associated with the event or determine the number of tags while performing the actions associated with the event.

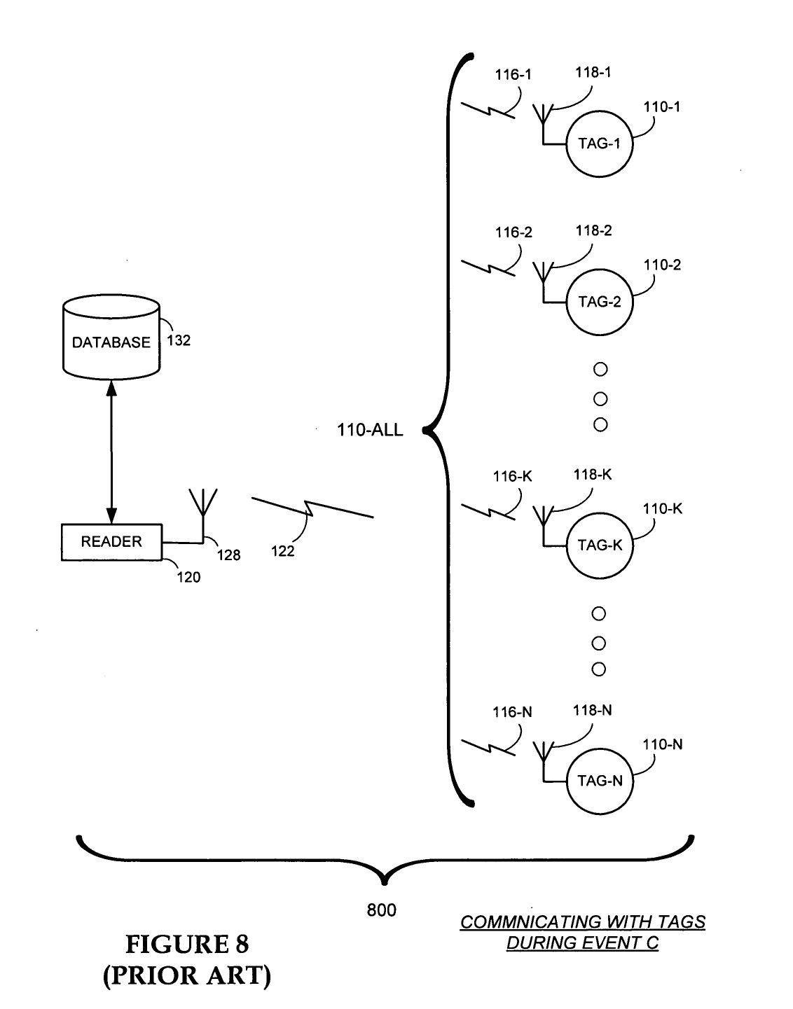

FIG. 8 is a diagram of an example RFID system 800, incorporating aspects of the invention. System 800 includes RFID reader 120 and N RFID tags 110-1, 110-2, . . . , 110-K, . . . , 110-N in the vicinity of each other and of reader 120. Reader 120 in system 800 is communicating with the tags during event C as described in FIG. 7A above.

RFID reader 120 has an antenna 128, and is in communication with database 132. Reader 120 transmits an interrogating Radio Frequency (RF) wave 122, which can be perceived by tags 110-1, 110-2, . . . , 110-K, . . . , 110-N.

RFID tags 110-ALL can be passive tags or active tags, i.e. having their own power source. Where tags 110-ALL are passive tags, they are powered from wave 122.

Each tag 110-X (X=1, 2, 3 . . . N) includes an antenna 118-X. Upon sensing interrogating RF wave 122, each tag 110-X may generate a wave 116-X in response. RFID reader 120 senses and interprets waves 116-X.

In FIG. 8, as in other figures, interrogating RF wave 122 is shown as larger than waves 116-X. This is to signify that interrogating RF wave 122 typically has a higher intensity.

Reader 120 and tag 110-X thus exchange data via waves 122 and 116-X. In a session of such an exchange, each encodes, modulates, and transmits data to the other, and each receives, demodulates, and decodes data from the other. The data is modulated onto, and decoded from, RF waveforms, as described previously.

Encoding the data can be performed in a number of different ways including protocols that are devised to communicate in terms of symbols. The bits and/or symbols used in communication may be named according to their function. For example, it is customary to refer to such groups as “commands”, “data”, “payload”, “handle”, and so on.

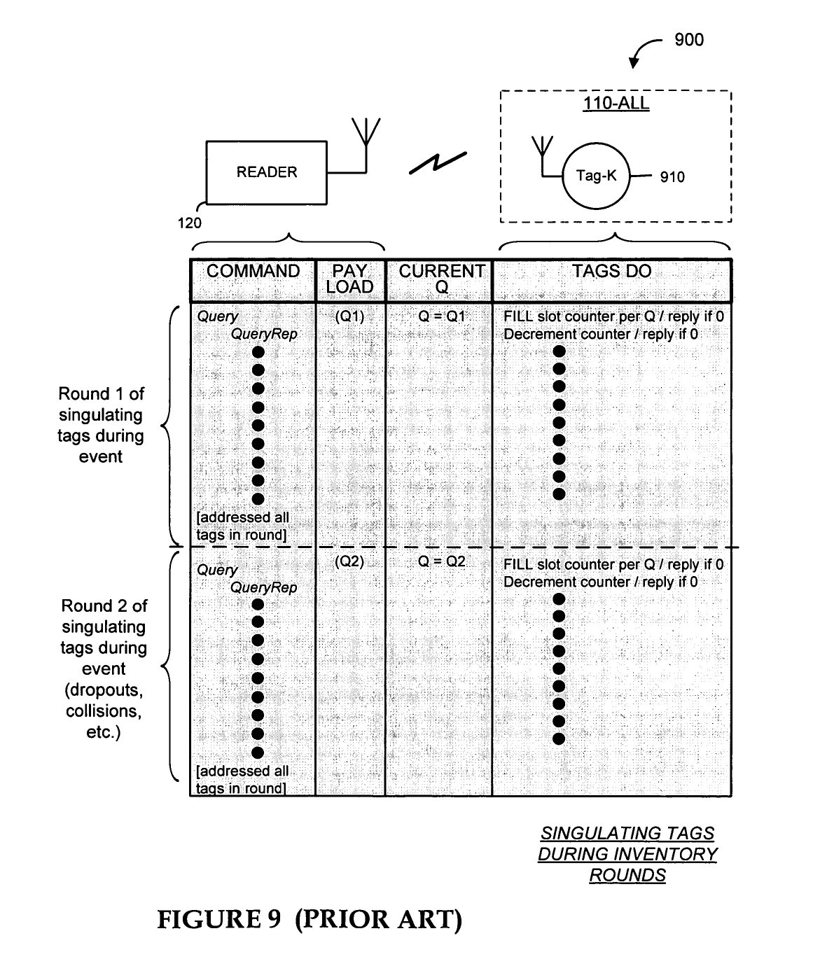

FIG. 9 illustrates action table 900 that includes actions for the RFID reader of FIG. 8 to singulate the RFID tags of FIG. 8 during inventory rounds.

Each time there is inventorying, a parameter is used that is called the Query command slot-count parameter “Q”. A reader communicates the Q to the tags, and the tags use the Q to respond. In particular, each tag uses its random number generation for Q to arrive at a binary number between 0 and 2^{Q}−1. Some tags may choose the same number. Some numbers may not be chosen by any tags.

The term “slot” refers to the available numbers between 0 and 2^{Q}−1, which may be chosen by the tags. Once the contents corresponding to the slots are generated based on tag replies (chosen by one or more tags, or not chosen), the reader can evaluate the slots and determine a new Q. Then, the reader requests another round of random numbers from the tags based on the new Q until all tags are inventoried.

Action table 900 illustrates actions associated with each round of communication between RFID reader 120 and tags 110-ALL within its field of view. First column of action table 900 shows the commands used in the communication. Second column shows a payload of the commands. Third column shows a Q-value used by the reader for that round of communications, and the fourth column shows the action undertaken by the tags in response to the commands.

During round 1 of singulating, Q is first communicated to the tags by using the inventory command Query with a selected Q-value Q1 in the command payload. Hence, the current Q-value is Q1 throughout round 1.

In response to the Query command with Q1, the tags fill their slot counters with randomly generated numbers based on Q as described previously. This is followed by a round of decrementing the slot counter content for each QueryRep command received and replying when the slot counter content reaches “0”. It is also possible for the randomly generated number to be “0” at the beginning. Then the tag sends its reply following the Query command. The reader transmits the QueryRep command until all tags are singulated and the contents generates based on the decrementing responses.

In the second round of singulating, the reader changed the Q value to Q2 and the same exchange of commands and replies is repeated with the random numbers generated based on Q2 this time.

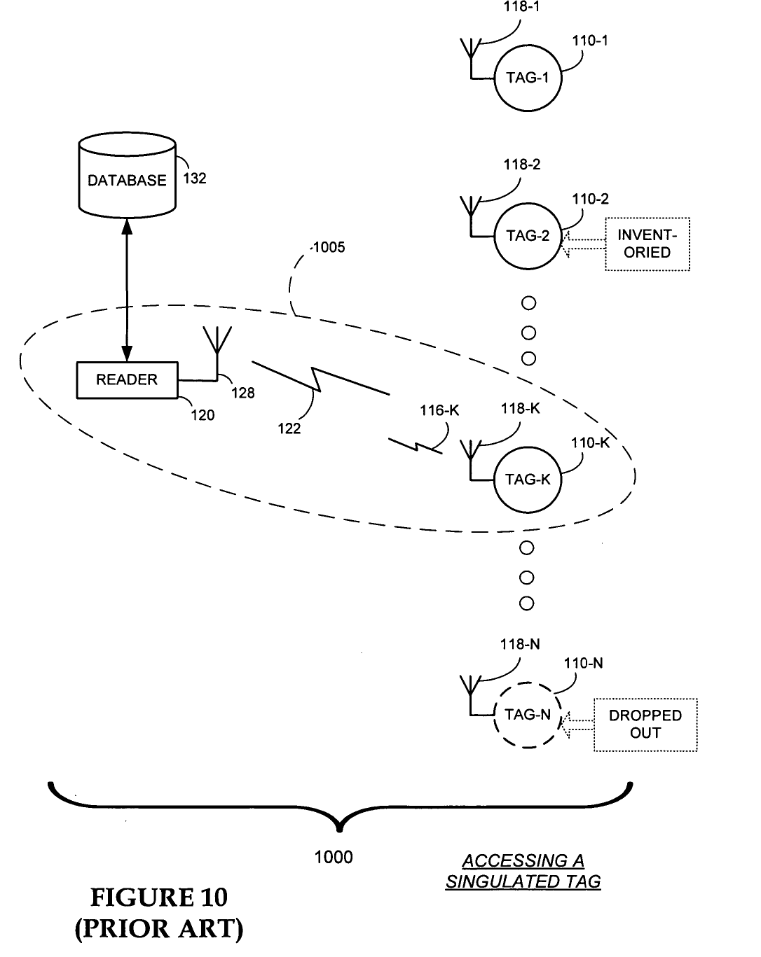

FIG. 10 illustrates the RFID system 1000, which was first presented in FIG. 8. In addition, RFID tag 110-K has been singulated by reader 120, as shown by relationship 1005. This singulation has caused all tags 110-X except tag 110-K to not transmit, so that reader 120 and singulated tag 110-K can exchange data without interference and reader 120 can access tag 110-K.

Reader 120 has accomplished singulation by first issuing appropriate commands, which have caused tags 110-X to transition to appropriate internal states. In this example, at least tag-K 110-K is in a state where it can receive an access-type command, while the remaining tags are in states where generally they do not respond or take action, until reader 120 and singulated tag 110-K complete their exchanges.

The term singulation, as used for the present document, generally means a process for distinguishing a tag from other tags. As such, singulation may be unnecessary when a single reader is addressing a single tag, or where there is no interference from, or concern about any other RFID components such as other RFID tags. The term singulation, as used here, may by coincidence be functionally the same as a specific term “singulation”, which means a process of a reader that can be performed with many or even a single tag.

The term accessing, as used for the present document, generally means a process for retrieving information stored at the tag and/or causing information stored at the tag to be modified. This may include receiving an identifier symbol, user-specified data, and the like, from the tag, as well as storing a new identifier symbol etc. at the tag. Accessing may further include causing one or more operational parameters of the tag to be changed such as a security mechanism.

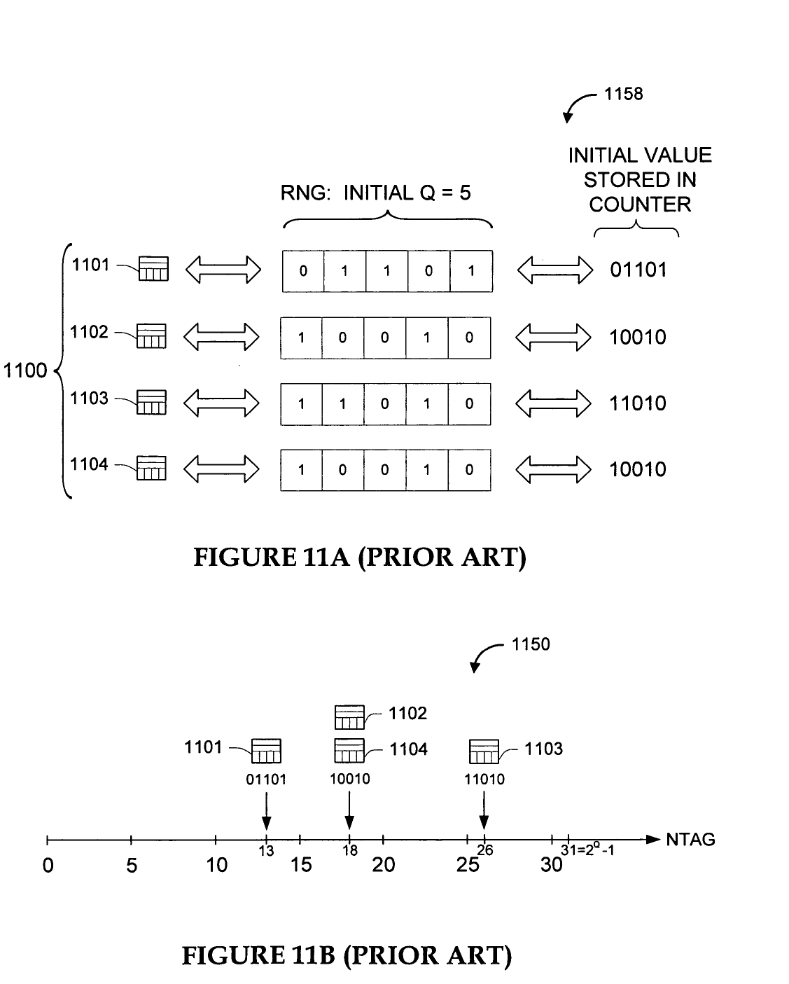

FIG. 11A illustrates diagram 1158 showing an example of tags filling their slot counters by Random Number Generators, in response to commands by an RFID reader.

As described previously, the reader guesses in an inventorying round as to how many tags there are. Then, it sets accordingly the Q parameter. The reader next issues a Query command and sends a number of QueryRep commands after that.

The Query command instructs the tags to load a Q-bit random number into their slot counter. For all commands, the reader records replies received from the tags. For each of the replies, there is a “slot”. Contents are generated for the slots based on the replies.

In diagram 1158, Q has a value of “5”. Accordingly, the four example tags generate 5-bit random numbers 1101 through 1104 that are initially stored in the slot counters.

FIG. 11B illustrates diagram 1150 showing how the numbers stored in the slot counters of FIG. 11A result in randomly chosen slots that arrange the RFID tags in an order to be accessed by an RFID reader.

As shown in the example diagram, two of the tags generate the same random number 1102 and 1104 (binary value: 10010), while the other two tags generate different numbers. This results in two slots “13” and “26” being filled by single replies and one slot “18” being filled with multiple (in this case two) replies. In the figure, the slots are represented along a linear axis of number of tags.

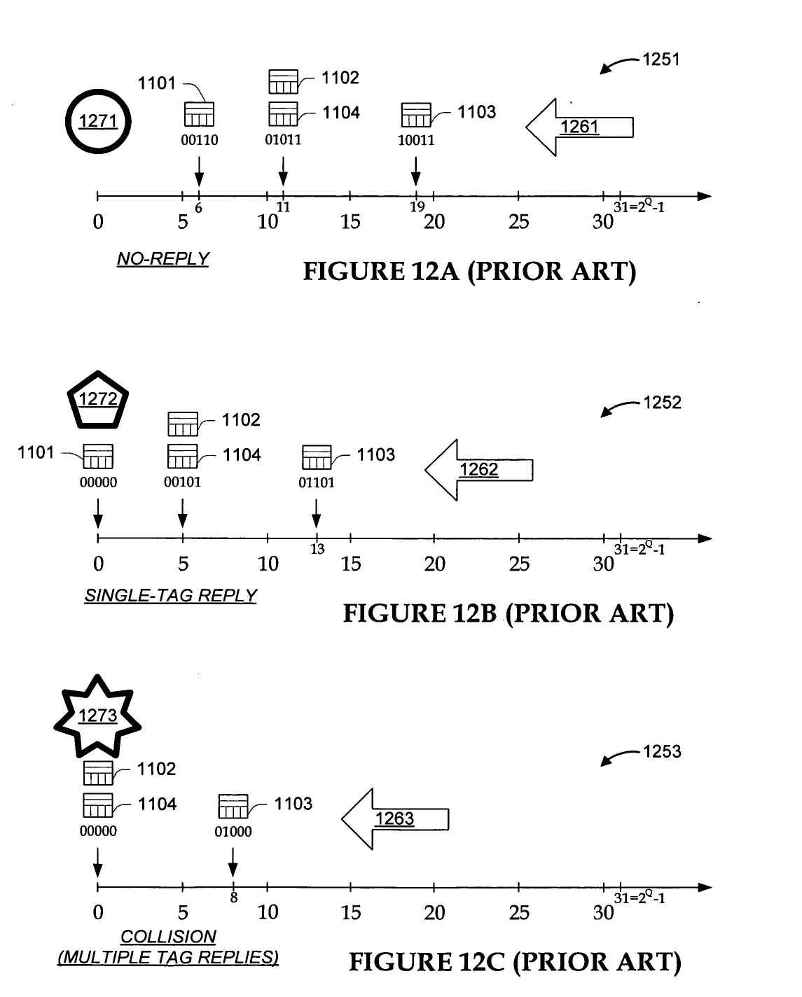

FIGS. 12A, 12B, and 12C are diagrams illustrating the result of decrementing the numbers stored in the slot counters of the RFID tags of FIG. 11B, and replying when it becomes zero.

A tag reply includes a code, such as a serial number. A content corresponding to slot is generated based on aggregating received tag replies. Accordingly, the content can have a value corresponding to no replies, single reply, or multiple replies. In one embodiment, the contents may include numeric values “0”, “1”, or “2” respectively corresponding to the number of received replies for that content.

While the numeric content values “0”, “1”, and “2” are used throughout the specification for example purposes, the invention is not limited to these values. Other content values may be used to represent no relies, single replies, and collisions, without departing from a scope and spirit of the invention.

After the initial Query command, the reader sends a number of QueryRep commands, each of which causes the tags to decrement the numbers in their slot counters. The numbers may be decremented sequentially or by a predetermined amount. The tags reaching the number zero in their slot counter respond to the reader. As a result of the decrementing and responding process, each time three outcomes are possible:
“empty contents” (no reply received—no tag identified with it),
“single reply contents” (exactly one reply received, from one tag), or
“collision contents” (more than one reply received, more than one tag).

Diagram 1251 shows an example of the first case. As a result of decrementing process 1261, none of the slot counters 1101-1104 reach zero. Accordingly, content 1271 is an empty content.

Diagram 1252 shows an example of the second case. As a result of decrementing process 1262, one of the tags reaches zero value in its slot counter (1101) and sends a reply to the reader. Accordingly, content 1272 is a single reply content.

Diagram 1253 shows an example of the third case. As a result of decrementing process 1263, two of the tags reach zero value in their slot counters (1102 and 1104) and send replies. Accordingly, content 1273 is a content with collisions. Although the collision slot 1273 is shown with two tags colliding in this example, many tags may collide in the same content in practice. Collision simply means, multiple tags responding for the same content.

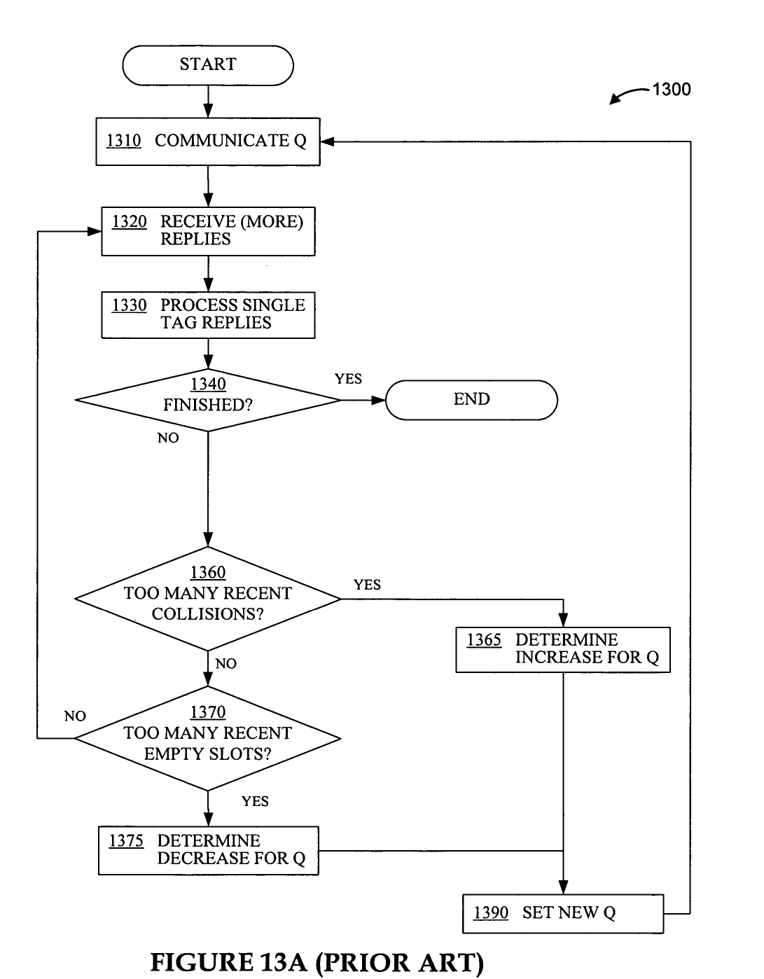

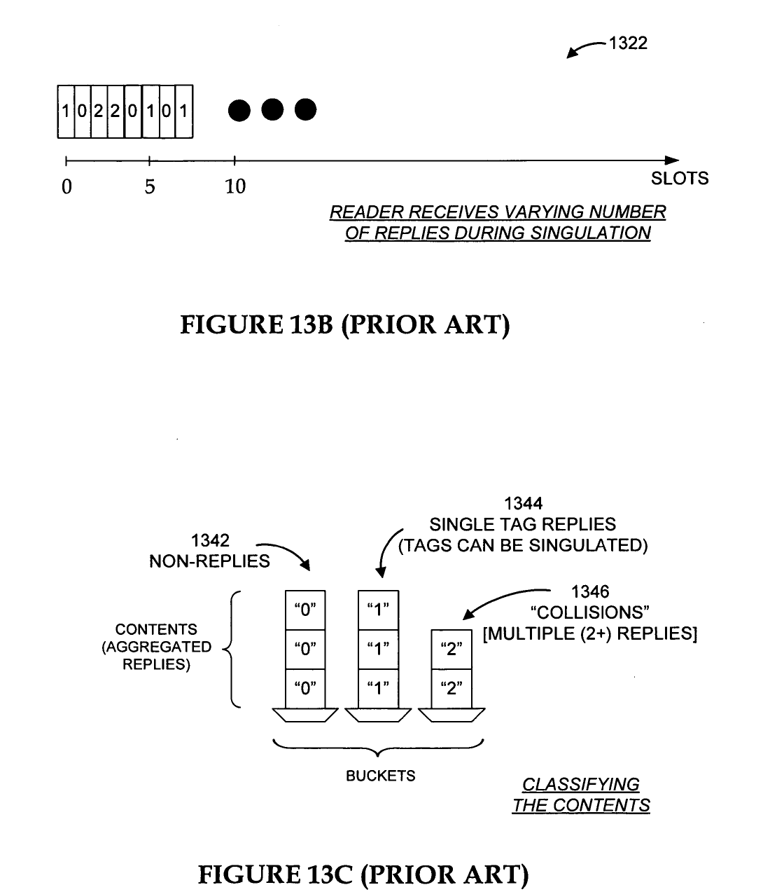

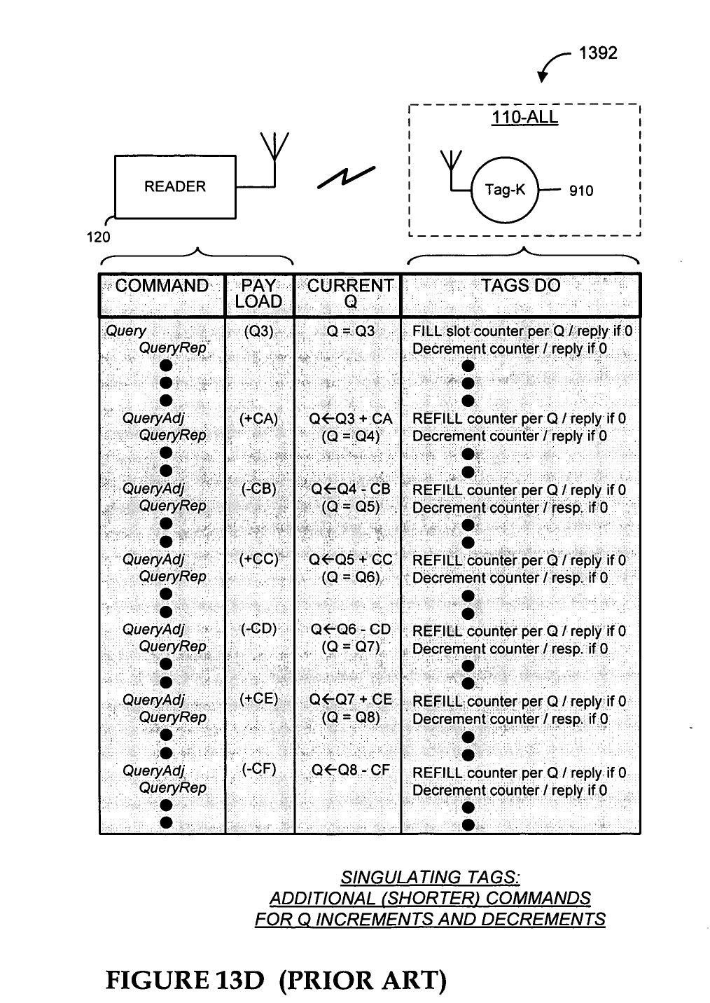

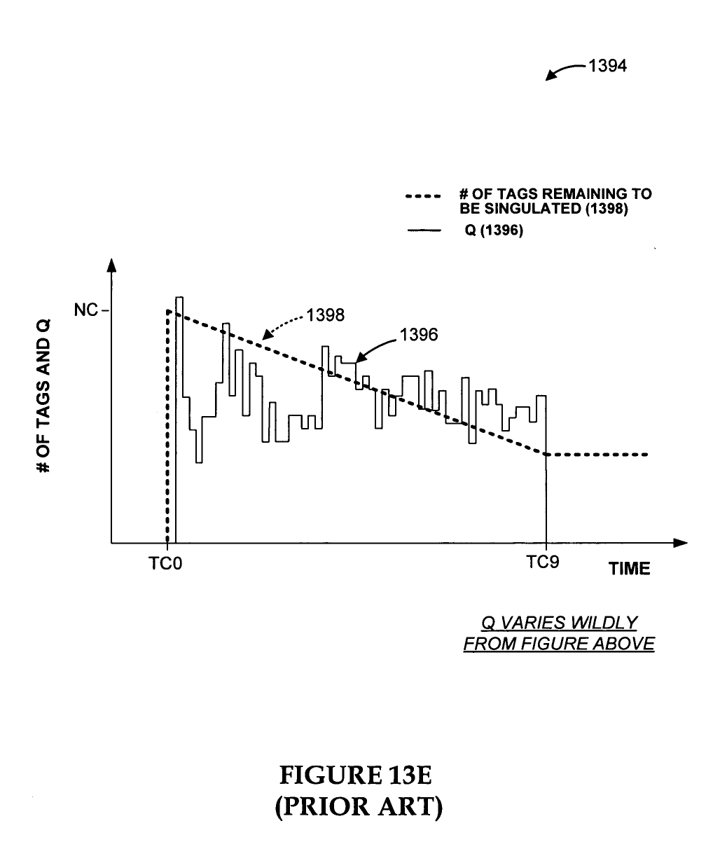

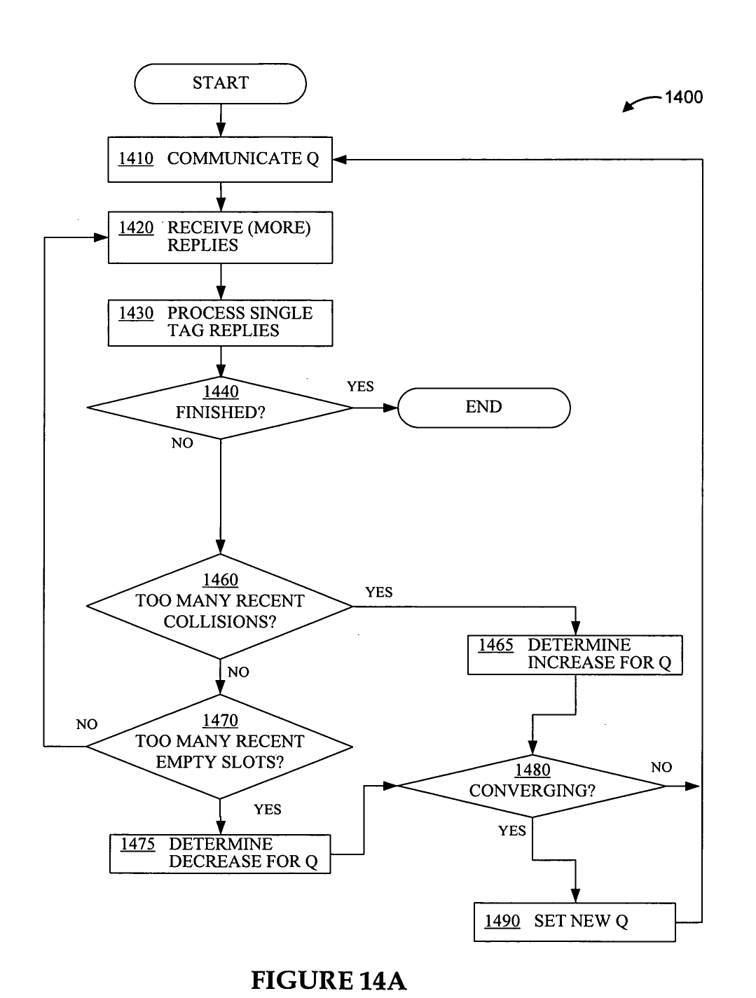

FIG. 13A is a flowchart illustrating process 1300 that is used to inventory tags by freely permitting a value of Q to increase and decrease freely.

Process 1300 begins with block 1310 where a reader addresses tags as described above in conjunction with FIG. 10.

Block 1310 is followed by block 1320, where contents are received in form of replies from tags. As the inventorying process is performed with repeated exchanges between the reader and the tags, more contents may be received from the tags. Processing then proceeds to block 1330.

At block 1330, single replies are processed. As the reader receives single replies for slots, it may instruct the replying tags to set an inventory flag such that the inventoried tag remains silent for the rest of the process as others are inventoried. The reader may further access the inventoried tags for other purposes. Processing then proceeds to decision block 1340.

At decision block 1340, a determination is made whether all single replies are processed. If all slots have single reply contents, they are processed and processing returns to block 1320 to receive more replies. If all single replies have been processed and all tags inventoried, inventorying process is completed and processing moves to a calling process for further actions.

If the determination at decision block 1340 is negative, processing proceeds to decision block 1360. At decision block 1360, a determination is made whether too many contents have collisions (two or more tag replies). The determination may be made based on a predetermined criterion.

If there are too many collisions, processing moves from decision block 1360 to block 1365 where an increase amount is determined for Q. Processing then proceeds to block 1390. At block 1390, the new increased Q value is applied and a new command sent to the tags requesting them to generate new random numbers based on the new Q value.

If the determination at decision block 1360 is negative, processing advances to decision block 1370 where a determination is made whether too many contents have no replies (empty slots). If the determination is affirmative, processing moves to block 1375.

At block 1375, a decrease amount is determined for Q. Processing then proceeds to block 1390. At block 1390, the new reduced Q value is applied and a new command sent to the tags requesting them to generate new random numbers based on the new Q value.

If the determination at decision block 1370 is negative, processing returns to block 1320 where more replies are received from the tags.

FIG. 13B includes time diagram 1322 showing example replies received according to a box of the flowchart of FIG. 13A. Slots are represented along the horizontal axis. As described before, the slots may be numbered based on Q (e.g. 2^{Q-1}). The boxes represent replies from tags for each slot.

For example, first slot corresponding to “0” on the horizontal scale, has received one reply, second slot corresponding to “1” has received no replies (empty slot), third slot corresponding to “2” has received multiple replies, and the like. Multiple replies, which can be two or more, are represented with number 2, even though there can be more than 2.

FIG. 13C is a diagram of classifying the replies received in the time diagram of FIG. 13B in buckets according to another box of the flowchart of FIG. 13A.

Classifying the slots in “non-reply” (empty) bucket 1342, “single reply” bucket 1344, and “collision” bucket 1346 may help compute statistics, which may be used to modify Q. Q may be increased or decreased, as described in conjunction with FIG. 13A, depending on whether there are too many collisions or empty slots. Accordingly, a number of contents in buckets 1342 and 1346 are employed to determine whether Q is to be increased or decreased.

In an example inventory process, the reader may complete the inventorying process without having to change Q if only bucket 1344 is filled.

FIG. 13D includes action table 1392, illustrating additional commands available to change quickly the value of Q by communicating only the increments and decrements according to the method of FIG. 13A.

First column of action table 1392 shows the commands used in the communication. Differently from action table 900, the command QueryAdj is used to start a new round of counting. QueryAdj repeats a previous Query and may increment or decrement Q, but does not introduce new tags into the round.

Second column shows a payload of the commands. The exchange begins, as in action table 900, with a Query command including Q3 in its payload. However, QueryAdj commands following the first round of counting include a change amount for Q in their payload. For example, the first QueryAdj includes+CA, meaning Q3 is to be increased by CA, and Q4=Q3+CA is to be used in the following round. The next QueryAdj command includes−CB, meaning Q5 for the following round is equal to Q4−CB.

The Q values are shown for each round of exchanges in the third column. The fourth column shows the action undertaken by the tags in response to the commands.

In response to the Query command, the tags fill their slot counters with randomly generated numbers based on Q as described previously. This is followed by a round of decrementing the slot counter content for each QueryRep command received and replying when the slot counter content reaches “0”. It is also possible for the randomly generated number to be “0” at the beginning. Then the tag sends its reply following the Query command.

After the first round of exchanges, the tags generate new random numbers based on the adjusted Q (such as Q4, Q5, and etc. shown in the figure) and refill their slot counters in response to each QueryAdj command.

Each QueryAdj command is followed by a round of QueryRep commands, which trigger the tags to decrement their slot counter contents and reply when the slot counter content reaches “0”.

One disadvantage of modifying Q as described here is that it tends to jump around, unrestrainedly, which is relatively inefficient (as shown in the following figure). Commands tend to be wasted in setting and resetting Q without making sufficient progress.

Another disadvantage of the frequent modification of Q approach is the situation where yet-uncounted tags drop out of the count for various reasons, e.g. by losing power. For example, a worker could walk in front of the reader, and block the reader's RF energy from reaching the tags. This may result in a slot that would have had a single response having none, one that would have had a collision having a single response, and the like.

FIG. 13E is an example time diagram 1394 illustrating the value of Q varying according to the method of FIG. 13A, along with the resulting number of tags that remain to be inventoried.

Number of tags NC represented along the vertical axis could be initially unknown (time point TC0). This may happen during a power-up, when many tags are in an open state or when a subgroup is isolated from a larger group (the latter can occur when a Select command is used).

Inventorying tags can also be performed by changing their state. This way, as a flag is counted, it is “removed”, and the addressed flags are the remaining uncounted flags. Thus, the very act of counting the tags changes (reduces) the addressed population.

In example time diagram 1394, the monotonically declining line (1398) is the number of uncounted tags, here the addressed number of tags. The other line (1396) shows the variation of a Query command slot-count parameter Q, which is used for inventorying.

As timing diagram 1394 shows, slot-count parameter Q varies wildly when the method described in FIG. 13A is employed. The variation of the number of tags and Q is reflected during event C designated by time points TC0 and TC9.

In some embodiments, a method for an RFID reader to address a plurality of RFID tags, which reply to the reader based on randomly choosing one of a plurality of slots in response to a communicated value of a Q parameter and according to their chosen slot, may begin by communicating a Q1 value for the Q parameter to the tags. The method may then include receiving first replies from the tags derived from communicating the Q1 value, generating first contents from the first replies, and computing a first merit statistic based on the first contents.

The reader may then communicate a Q2 value for the Q parameter, and receive second replies from the tags as derived from communicating the Q2 value. Second contents are generated from the second replies, and a second merit statistic computed based on the second contents. A Q3 value for the Q parameter may be determined from the first statistic and the second statistic.

If the Q3 value is different from the Q2 value, a portion of the tags may be addressed by communicating the Q3 value for the Q parameter, and third contents with replies from third tags derived from communicating the Q3 value inputted.

On the other hand, if the Q3 value is substantially equal to the Q1 value, receiving the second replies may be continued without communicating the Q3 value.

In another embodiment, the method may further include computing a third merit statistic based on the third contents and determining whether the third statistic is less desirable than one of the first and second statistics according to a criterion.

If the third statistic is less desirable than one of the first and second statistics, a Q4 value for the Q parameter may be determined from the Q1 and Q2 values, and the reader may communicate the Q4 value for the Q parameter to a portion of the tags.

The first statistic and the second statistic may be respective values of a merit function associated with processing tags whose replies are received. The merit function may include a throughput function associated with a number of tags that are processed or a count of slots that contain a single tag reply. The merit function may also be an inverse of a cost function.

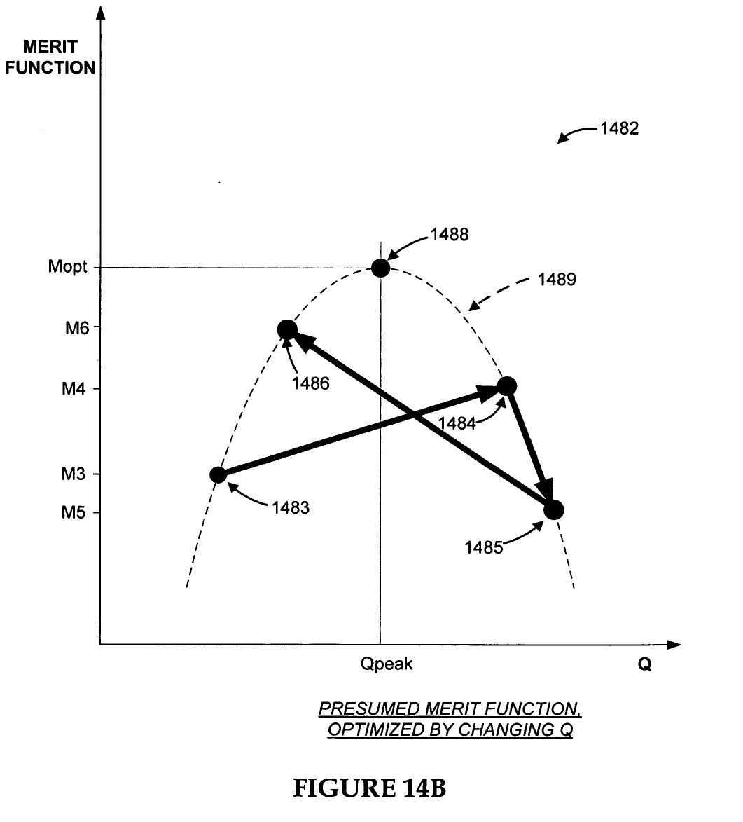

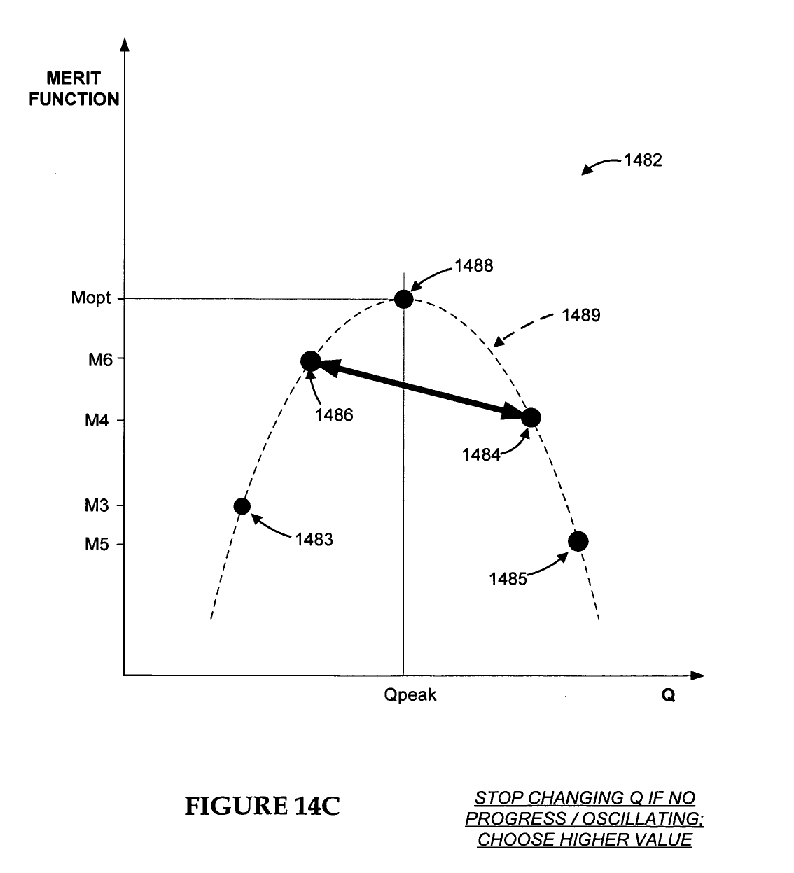

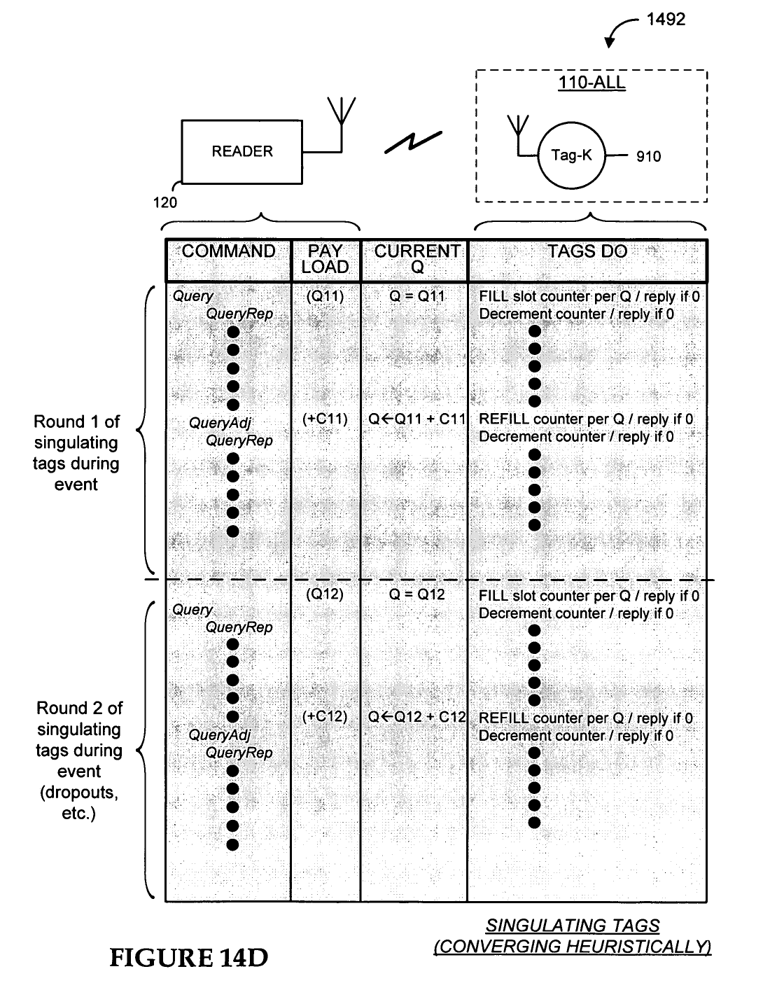

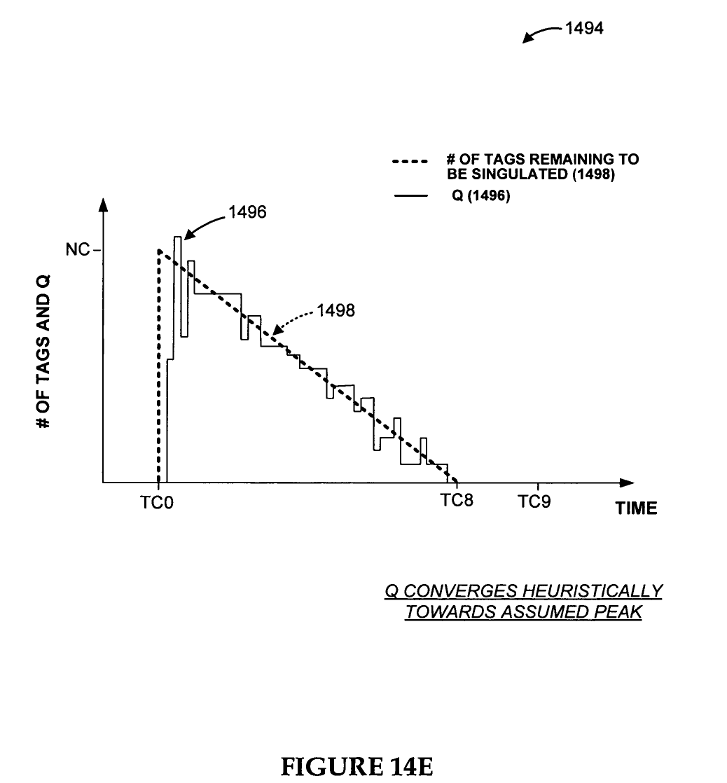

FIG. 14A is a flowchart illustrating process 1400 for a method of determining Q by converging heuristically to an assumed peak of a merit function. Process 1400 may be implemented in an RFID reader such as RFID reader 120 of FIG. 1.

Process 1400 begins with block 1410 where a reader communicates a Q value to the tags as described previously in conjunction with FIG. 10.

Block 1410 is followed by block 1420, where replies are received from tags. As the inventorying process is performed with repeated exchanges between the reader and the tags, more replies may be received from the tags. Processing then proceeds to block 1430. As the reader receives the replies, contents corresponding to slots are generated based on the replies. Different contents may include no replies, single replies, and collisions.

At block 1430, single replies are processed. As the reader receives single replies for slots, it may instruct the replying tags to set an inventory flag such that the inventoried tag remains silent for the rest of the process as others are inventoried. The reader may further access the inventoried tags for other purposes. Processing then proceeds to decision block 1440.

At decision block 1440, a determination is made whether all single replies are processed. If all single replies have been processed and all tags inventoried, inventorying process is completed and processing moves to a calling process for further actions.

If the determination at decision block 1440 is negative, processing proceeds to decision block 1460. At decision block 1460, a determination is made whether too many slots have collisions (two or more tag replies). The determination may be made based on a predetermined criterion.

If there are too many collisions, processing moves from decision block 1460 to block 1465 where an increase amount is determined for Q. Processing then proceeds to decision block 1480.

If the determination at decision block 1460 is negative, processing advances to decision block 1470 where a determination is made whether too many slots have no replies (empty slots). If the determination is negative, processing returns to block 1420 where more replies are received from the tags. If the determination is affirmative, processing moves to block 1475.

At block 1475, a decrease amount is determined for Q. Processing then proceeds to decision block 1480.

At decision block 1480, a determination is made whether the Q value is converging. As discussed in more detail below, in conjunction with FIGS. 14B and 14C, the determination may be accomplished by computing a new merit statistic based on additional contents and determining whether the new merit statistic is less desirable than the first and second statistics computed from previous contents. The comparison of the statistics may be performed according to a predetermined criterion.

In one embodiment, previous statistics may be respective values of a merit function associated with processing tags whose replies are received. The merit function may include a throughput function associated with a number of tags that are processed or a count of slots that contain a single tag reply. The merit function may also be an inverse of a cost function. Processing advances from block 1480 to block 1490.

At block 1490, the new Q value, which may be increased or decreased from the previous Q value, is set. Processing then returns to block 1410, where the new Q value is communicated to the tags, and the process is repeated.

FIG. 14B is diagram 1482 illustrating heuristically trying various values for Q with a view to optimize a presumed merit function according to one embodiment.

Merit function 1489 shown in diagram 1482 has an optimum value Mopt at its peak. Various other values of merit function 1489 are shown along the vertical axis as M3, M4, M5, and M6.

For optimum efficiency in inventorying tags, a goal of a method for determining Q is to reach Mopt at point 1488 as rapidly as possible. Using a method as described above, an initial value of Q may correspond to point 1483 (M3 of merit function 1489). At next step, the method may jump to point 1484 corresponding to M4, which is closer to Mopt.

However, a next step of the method may determine a Q value that moves farther from the optimum value, as shown at point 1485, corresponding to M5. This may be corrected in the following step by jumping to point 1486 corresponding to M6. Accordingly, the Q value heuristically converges to an optimum.

FIG. 14C is diagram 1482, this time illustrating preventing Q from changing quickly if it has reached a value that is close to a longer term optimized Q value according to another embodiment.

Diagram 1482 of FIG. 14C shows Q having approached optimum value Mopt at point 1488, but oscillating between 1486 and 1484. In such as scenario, further variation of Q may result in distancing from the optimum value of the merit function and wild variations of Q such as those shown in FIG. 13E.

To avoid loss of efficiency, an algorithm for determining Q may be adjusted such that changing Q is stopped, when such an oscillation point is reached. In one embodiment, the algorithm may select the higher of the two values for Q expecting that value will approach closer to the optimum of the merit function.

FIG. 14D shows action table 1492, reflecting commands that change the value of Q relatively less often according to the method of FIG. 14A.

First column of action table 1492 shows the commands used in the communication. Differently from action table 1392, two rounds of singulating are used during the event. As before, QueryAdj repeats a previous Query and may increment or decrement Q, but does not introduce new tags into the round.

Second column shows a payload of the commands. The exchange begins, as in action table 1392, with a Query command including Q11 in its payload. However, QueryAdj commands following the first set of counting include a change amount for Q in their payload. For example, the first QueryAdj includes +C11, meaning Q11 is to be increased by C11, and Q=Q11+C11 is to be used in the following set.

At each set of exchanges, the tags generate new random numbers based on the adjusted Q and refill their slot counters in response to each QueryAdj command.

Each QueryAdj command is followed by a group of QueryRep commands, which trigger the tags to decrement their slot counter contents and reply when the slot counter content reaches “0”.

The Q values are shown for each set of exchanges in the third column. The fourth column shows the action undertaken by the tags in response to the commands.

In response to the Query command, the tags fill their slot counters with randomly generated numbers based on Q as described previously. This is followed by a round of decrementing the slot counter content for each QueryRep command received and replying when the slot counter content reaches “0”. It is also possible for the randomly generated number to be “0” at the beginning. Then the tag sends its reply following the Query command.

After the first round of singulating, the number of tags in the population may change due to dropouts, new tags entering the field of view etc. Thus, a new Query is issued with Q12 and incremented by C12.

In determining Q12 from the last value of Q of the first round of singulating, a heuristic convergence method may be employed as described in conjunction with FIG. 14A allowing efficient convergence of Q to a fairway condition.

FIG. 14E is example time diagram 1494 illustrating the value of Q varying according to the method of FIG. 14A, along with the resulting number of tags that remain to be inventoried.

As before, the number of tags (NC) represented along the vertical axis could be initially unknown (time point TC0).

Inventorying tags can also be performed by changing their state. This way, as a flag is counted, it is “removed”, and the addressed flags are the remaining uncounted flags. Thus, the very act of counting the tags changes (reduces) the addressed population.

In example time diagram 1494, the monotonically declining line (1498) is the number of uncounted tags, here the addressed number of tags. The other line (1496) shows the variation of a Query command slot-count parameter Q, which is used for inventorying.

As timing diagram 1494 shows, slot-count parameter Q converges heuristically when the method described in FIG. 14A is employed. The variation of the number of tags and Q is reflected during event C designated by time points TC0 and TC9. Q and the number of uncounted tags reach zero at time point TC8 before the end time point TC9 of event C.

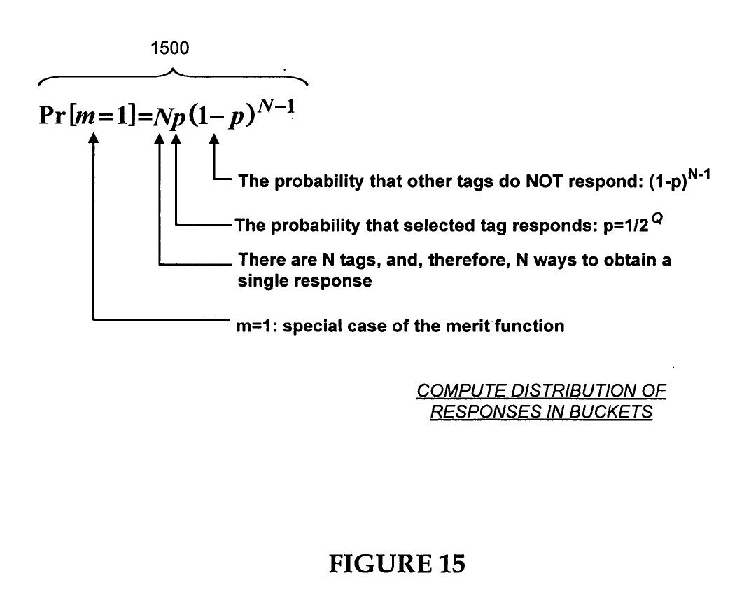

FIG. 15 illustrates example computation 1500 of a probability of replies from RFID tags to an initial query by an RFID reader.

The distribution of tag responses in buckets may be computed by employing the equation shown in example computation 1500. As shown in the figure, a probability of a response containing one tag (single response) is represented by Pr[m=1], where m represents a tag number and m=1 is a special case of the merit function.

The probability is equal to Np(1−p)^{N-1}, where N is the total number of tags. Therefore, there are N ways to obtain a single response. p is the probability that a particular tag responds. If there are 2^{Q} slots available, p is 1/(2^{Q}).

Lastly, (1−p)^{N-1} represents the probability that other tags do not respond when the particular tag is responding.

Using example computation 1500, the distribution of tag responses for different categories (buckets) such as single responses may be determined.

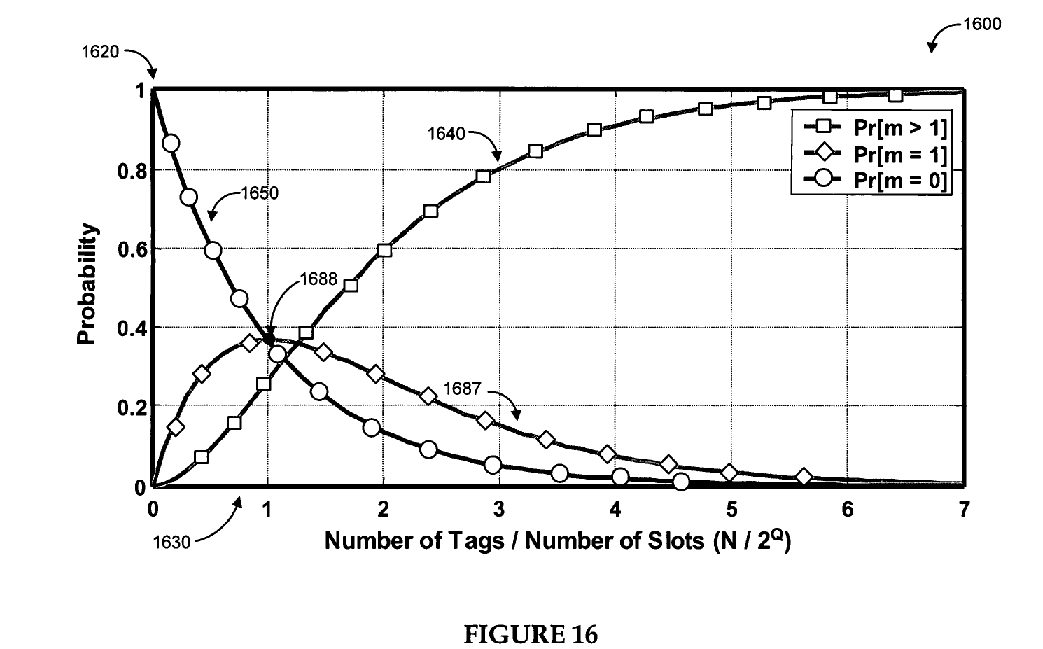

FIG. 16 illustrates diagram 1600 including probability plots of various replies according to the computation of FIG. 15.

In diagram 1600, plot 1640 represents the probability of multiple tag replies (collisions) against number of tags (or number of slots). Vertical axis 1620 is the probability and horizontal axis 1630 is number of tags over number of slots (N/(2^{Q}). As the diagram shows, plot 1640 increases monotonically with the number of tags asymptotically approaching probability one.

Plot 1650 represents the probability of no tag replies (empty slots). Plots 1650 starts at probability one and decreases monotonically, asymptotically approaching probability zero.

Plot 1687 is the special case shown in FIG. 15 for single tag replies. Plot 1687 starts at probability zero, increases monotonically until it reaches a maximum, and decreases monotonically approaching probability zero.

Peak efficiency for evaluating tag responses occurs when 2^{Q} equal the number of tags, thus at the maximum of plot 1687. Accordingly, point 1688 indicates the optimum value for a merit function.

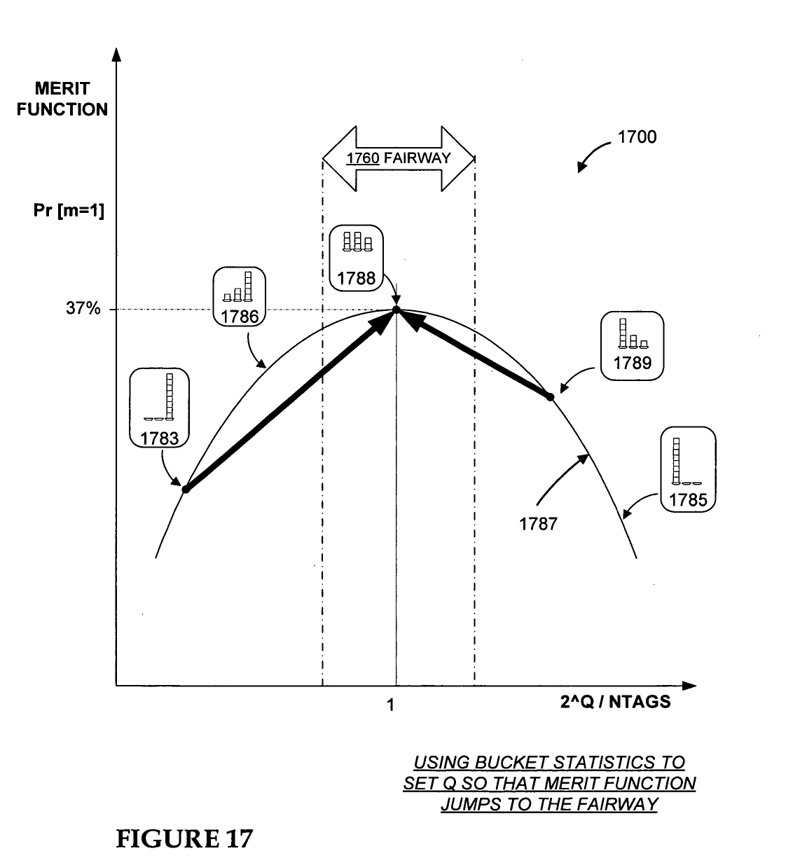

FIG. 17 includes diagram 1700, which illustrates one of the plots of FIG. 16 as a merit function, and further includes an optional fairway around an optimum point, and corrections to Q values for various operating points, so that overall performance enters the fairway.

The merit function chosen for diagram 1700 is Pr[m=1]. It should be noted that m=1 corresponds to a nominally optimum value. In practice, an actual optimum can be different, especially if there is some ability to distinguish between collided replies.

Regardless, the chosen merit function reaches an optimum value around 1/e (=37%) based on number of tags N being equal to 2^{Q}. On either side of the merit function (1787) away from the optimum point, the distribution of the buckets is least optimum. For example, the bucket distribution for 1783 indicates a high number of collisions while no replies and single replies do not exist.

Conversely, the bucket distribution for 1785 indicates a high number of no replies while collisions and single replies do not exist. Whereas bucket distributions 1786 and 1789 indicate improved distribution with the addition of slots filled with the missing reply categories, the improvements are not at an optimum level.

Bucket distribution 1788 is the optimum distribution at the peak of merit function 1787.

The above described bucket statistics may be used to set values of Q such that a determination algorithm jumps to a fairway (1760) that is defined around the peak of the merit function. For example, an algorithm for determining Q may jump from a point on merit function 1787 corresponding to bucket distribution 1783 to the peak. Similarly, if the starting point of another algorithm corresponds to bucket distribution 1789, the algorithm may jump next to the peak reaching optimum bucket distribution 1788.

Embodiments of the present invention described herein, in conjunction with FIGS. 14A through 14E, 15, 16, and 17, may be practiced in various combinations with embodiments of inventions described in conjunction with other figures and in related applications referenced at the beginning of this document.

A method for an RFID reader to address a plurality of RFID tags, which reply to the reader based on randomly choosing one of a plurality of slots in response to a communicated value of a Q parameter and according to their chosen slots, may begin, according to some embodiments, by communicating a Q1 value for the Q parameter to the tags. First replies from the tags derived from communicating the Q1 value are received and first contents may be generated based on the first replies. A first merit statistic may be computed based on the first contents.

A Q2 value may be determined for the Q parameter which, if communicated to the tags would result in prospective replies that would result in an expected second merit statistic computed similarly to the first merit statistic, and which would meet a preset fairway condition in a more desirable manner than the first merit statistic according to a preset criterion. Next, the Q2 value for the Q parameter may be communicated to a portion of the tags.

In another embodiment, second contents may be generated based on second replies from the tags derived from communicating the Q2 value, and a second merit statistic computed based on the second contents.

A Q3 value may be determined for the Q parameter which, if communicated to the tags it would result in prospective replies that would result in an expected third merit statistic that would meet the preset fairway condition in a more desirable manner than the second merit statistic according to the criterion.

Following the determination of the Q3 value, the Q3 value for the Q parameter may be communicated to a portion of the tags.

The first merit statistic may be a value of a merit function associated with processing tags whose replies are received, and the expected second merit statistic may be an expected value of the merit function associated with processing tags whose replies are expected to be received.

Furthermore, the fairway condition may be described in terms of at least one target value of the merit function, and the criterion may be that the expected second merit statistic has less distance from the fairway condition than the first merit statistic.

In further embodiments, the fairway condition may be a single valued performance parameter or a range for a performance parameter. The method may also include adjusting the fairway parameter.

The merit function may include a throughput function or it may be determined from an inverse of a cost function.

Where at least some of the first contents include single replies, the merit function may be determined from a count of the single replies.

In yet other embodiments, the first statistic may be derived from those of the first contents that include single replies compared to all of the first contents, and the Q2 value may be determined such that the expected second merit statistic exceeds a threshold. In one example embodiment, the threshold may be about 30%.

In yet further embodiments, the first statistic may be derived from those of the first contents that include no replies compared to all of the first contents, and the Q2 value may be determined such that the expected second merit statistic is within a preset range of values. In another example embodiment, the range of values may be between about 20% and about 60%.

The first statistic may also be derived from those of the first contents that include collided replies compared to all of the first contents, and the Q2 value may be determined such that the expected second merit statistic is within a preset range of values. In a further example embodiment, the range of values may be between about 10% and about 40%.

Finally, the first statistic may be a ratio with a numerator representing the first contents that include one of no replies, single replies and collided replies and a denominator representing the first contents that include another one of no replies, single replies and collided replies, and the Q2 value determined such that the expected second merit statistic is within a range.

In one embodiment, a metric of confidence may be computed for how well the first statistic meets the fairway condition. If the metric of confidence is below a predetermined confidence threshold, additional first contents may be inputted and the first statistic recomputed. Then a re-determination may be made whether the first statistic does not meet the fairway condition.

The confidence threshold may be described in terms of at least one confidence parameter, and the confidence parameter may be adjusted in the process of determining a value for Q.

The metric of confidence may also include a ratio of those of the first contents that include single tag replies to the total number of the first contents, where the threshold is ¼.

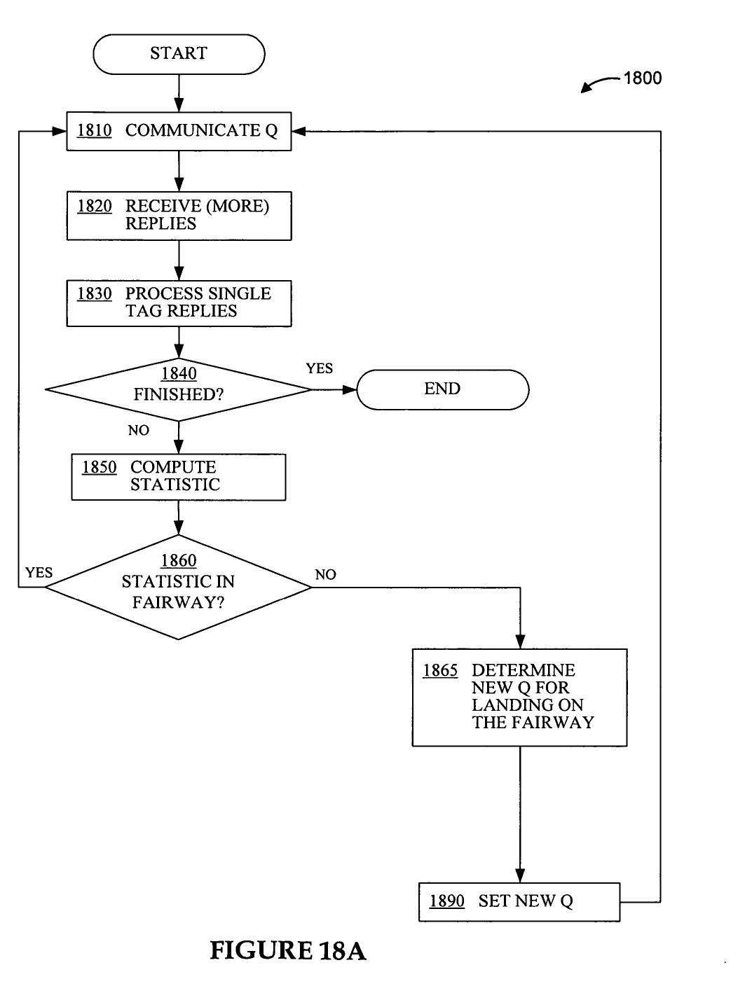

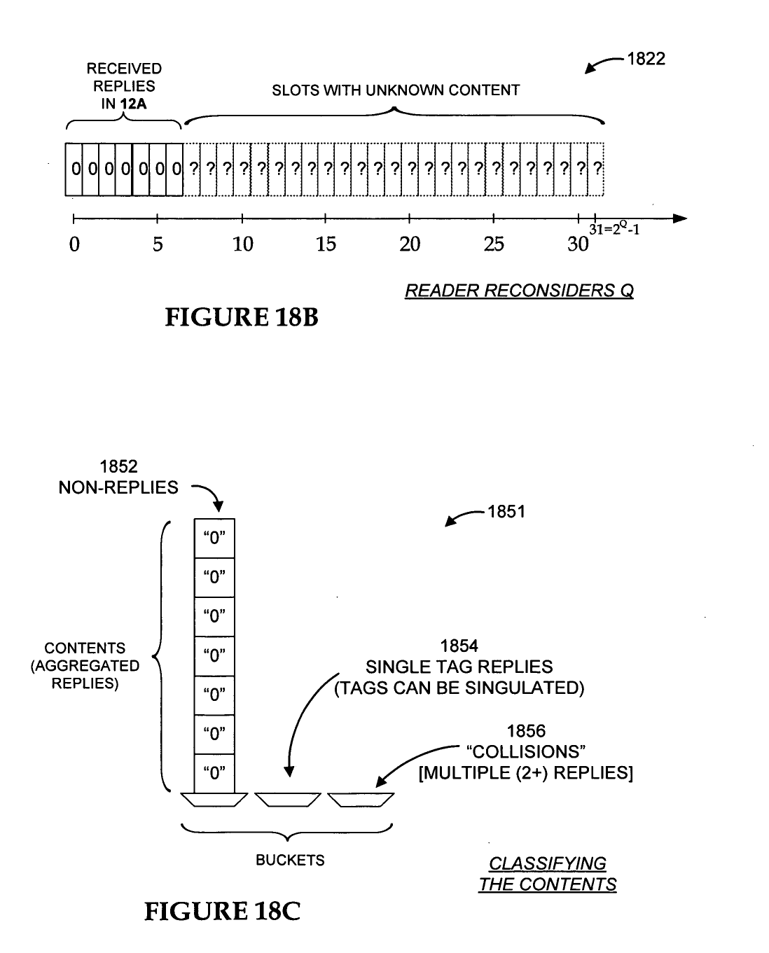

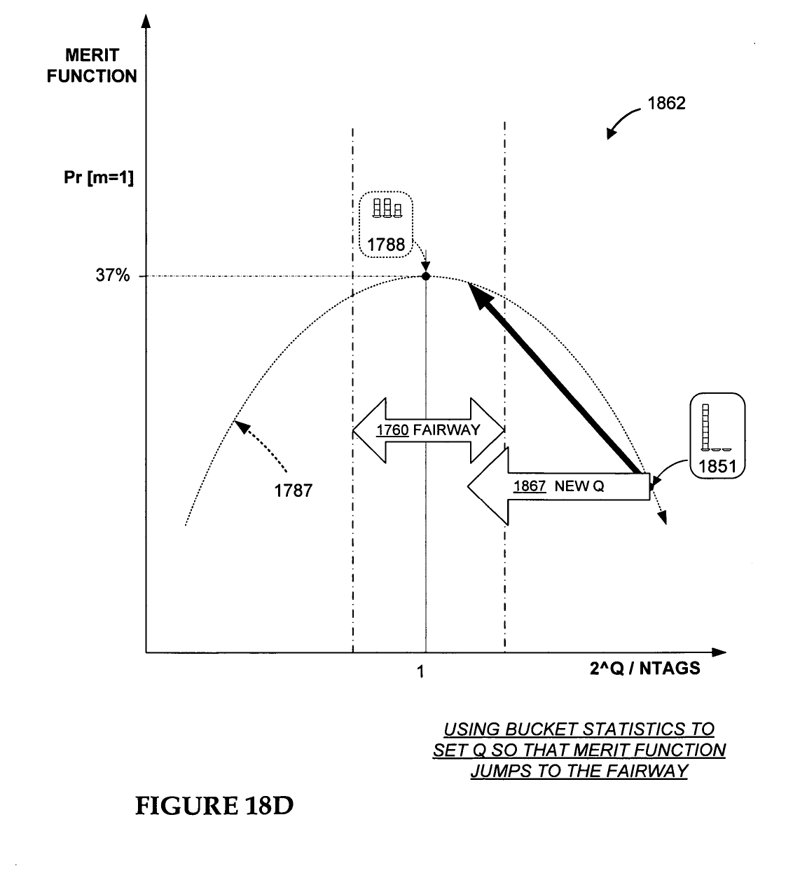

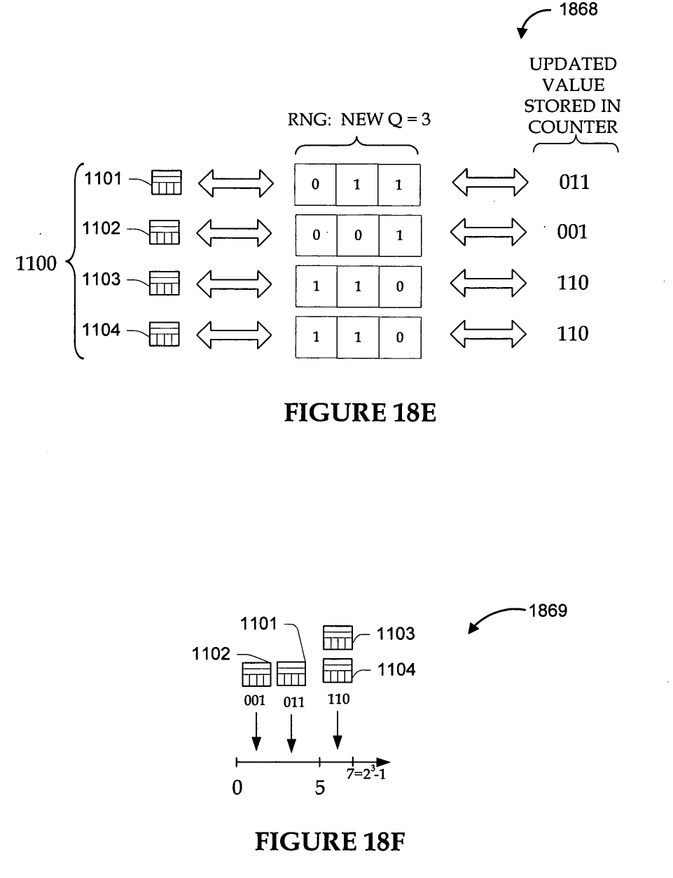

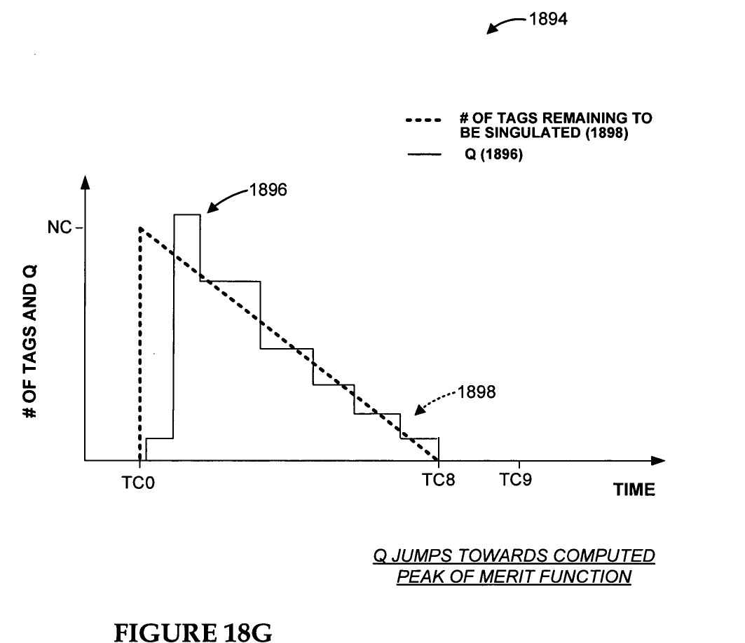

FIG. 18A is a flowchart illustrating process 1800 for a method that can be used to inventory tags by adjusting a value of Q such that a performance enters a fairway according to one embodiment. Process 1800 may be implemented in an RFID reader such as RFID reader 120 of FIG. 1.

Process 1800 begins with block 1810 where a reader communicates a Q value to the tags as described previously in conjunction with FIG. 10.

Block 1810 is followed by block 1820, where replies are received from tags. As the inventorying process is performed with repeated exchanges between the reader and the tags, more replies may be received from the tags. Processing then proceeds to block 1830.

At block 1830, single replies are processed. As the reader receives single replies for slots, it may instruct the replying tags to set an inventory flag such that the inventoried tag remains silent for the rest of the process as others are inventoried. The reader may further access the inventoried tags for other purposes. Processing then proceeds to decision block 1840.

At decision block 1840, a determination is made whether all single replies are processed. If all single replies have been processed and all tags inventoried, inventorying process is completed and processing moves to a calling process for further actions.

If the determination at decision block 1840 is negative, processing proceeds to block 1850. At block 1850, a statistic is computed. The statistic may be used to determine whether the fairway condition is reached or not. For example, a first merit statistic may be computed based on the first contents. Processing then proceeds to decision block 1860.

At decision block 1860, a determination is made whether the fairway condition is reached based on the first statistic computed at block 1850. If the decision is affirmative, the Q value is not modified and processing returns to block 1810 to communicate the Q value to the tags for another round of inventorying.

If the determination at decision block 1860 is negative, processing advances to block 1865 where a new Q value is determined for landing on the fairway. For example, a new Q value may be determined which, if communicated to the tags would result in prospective replies contained within prospective second slots which in turn would result in an expected second merit statistic computed similarly to the first merit statistic, and which would meet the preset fairway condition better than the first merit statistic.

In another embodiment, the fairway condition may be modified instead of changing the value of Q, or Q and the fairway condition may be changed at the same time.

Block 1865 is followed by block 1890, where the new Q value is set. Processing then returns to block 1810, where the new Q value is communicated to the tags and the process is repeated.

FIG. 18B is time diagram 1822 illustrating contents generated from received replies of the tags of FIG. 11A, after the tags have been queried up to approximately the stage of FIG. 12A, according to a box of the flowchart of FIG. 18A, along with the unknown contents that have yet to be received.

Slots are represented along the horizontal axis. As described before, the slots may be numbered based on Q (e.g. 2^{Q}−1). The boxes represent contents generated from tag replies for each slot.

First six slots have received no replies (empty slot) based on the example of FIG. 12A. The contents of the remaining slots are unknown. The reader is reconsidering Q, because the selected Q value has not provided any single reply slots so far.

FIG. 18C illustrates diagram 1851 for processing the categorized contents of FIG. 18B according to another box of the flowchart of FIG. 18A.

The buckets represent different categories of contents with tag replies. Bucket 1852, filled with replies received in FIG. 12A (also shown in FIG. 18B), is the category of non-replies. These are the slots where no tag has replied.

Bucket 1854 (shown empty in the figure) is the category of single tag replies. In one scenario, all slots may be categorized in bucket 1854 meaning all tags have provided single replies. In that case, the reader can complete the inventorying process in one step without having to change Q and to send another Query to the tags.

Bucket 1856 is the category of collisions or multiple tag replies. Replies from two or more tags may collide in one slot. Such tags cannot be inventoried by the reader and another round of querying and evaluating responses is needed. Bucket 1856 is shown empty in this example diagram based on the received replies of FIG. 12A.

FIG. 18D is diagram 1862 repeating the plot of FIG. 17, identifying an operating point according to the processed contents of FIG. 18C, and determining a value of a new Q for a performance to enter the fairway.

Diagram 1862 includes merit function 1787, the special case function for Pr[m=1]. As discussed previously, a nominally optimum point of merit function 1787 may be at about 37% (≈1/e) or at the peak of the function, which corresponds to bucket distribution 1788 for optimally efficient content distribution.

Fairway 1760 is defined as the region around the nominally optimum point of merit function 1787. As shown in the figure, an initial value of Q results in bucket distribution 1851 with a number of empty slots and no single replies or collisions.

Based on the method described in conjunction with FIG. 18A, an algorithm for determining Q jumps along the merit function to the fairway. This results in a new Q value (1867) in the fairway.

In another embodiment, fairway 1760 may be expanded to include a Q value, if Q is considered sufficiently close to the optimum point and the iteration completed without further modifying Q.

FIG. 18E is diagram 1868 illustrating an example of the tags of FIG. 11A after filling again their slot counters by Random Number Generators, in response to commands by an RFID reader communicating an updated Q learned from considering FIG. 18D.

As described previously, the reader guesses in an inventorying round as to how many tags are there. Then, it sets the Q parameter accordingly. The reader issues next a Query command and sends a number of QueryRep commands after that.

The Query command instructs the tags to load a Q-bit random number into their slot counter. For all commands, the reader records replies received from the tags. For each of the replies, there is a “slot”.

In diagram 1868, the new value for Q is “3”. Accordingly, the four example tags (1101, 1102, 1103, and 1104) generate 3-bit new random numbers 011, 001, and 110. The slot counters are then updated with the new random numbers.

FIG. 18F is diagram 1869 illustrating how the tags of FIG. 18E have been redistributed in a way that is more advantageous than that of FIG. 11B.

As shown in the example diagram, tags 1102 and 1101 generate binary numbers 001 and 011, respectively. Tags 1103 and 1104 generate the same random binary number 110. This results in two slots (1) and (3) being filled by single replies and one slot (6) being filled with multiple (in this case two) replies. In the figure, the slots are represented along a linear axis of number of tags.

The contents in diagram 1869 are not only somewhat evenly distributed, but they are also closer to each other than in FIG. 11B (i.e. much fewer empty slots in between). Accordingly, fewer QueryRep commands followed by decrementing of random numbers and replies by the tags have to be issued by the reader to process this distribution, thereby increasing overall efficiency of the inventorying process.

FIG. 18G is example time diagram 1894 illustrating the value of Q varying according to the method of FIG. 18A, along with the resulting number of tags that remain to be inventoried.

As before, the number of tags (NC) represented along the vertical axis could be initially unknown (time point TC0).

In example time diagram 1894, the monotonically declining line (1898) is the number of uncounted tags, here the addressed number of tags. The other line (1896) shows the variation of a Query command slot-count parameter Q, which is used for inventorying.

As timing diagram 1894 shows, slot-count parameter Q jumps towards a computed peak of the presumed merit function when the method described in FIG. 18A is employed. The variation of the number of tags and Q is reflected during event C designated by time points TC0 and TC9. Q and the number of uncounted tags reach zero at time point TC8 before the end time point TC9 of event C. Q changes throughout the inventorying process in fewer increments than any other embodiments illustrated in this specification.

Embodiments of the present invention described herein, in conjunction with FIGS. 18A through 18G, may be practiced in various combinations with embodiments of inventions described in conjunction with other figures and in related applications referenced at the beginning of this document.

In some embodiments, the manner of computing Q may also be changed, while computing a new value for the Q-parameter. A Q1 value for the Q parameter may be determined in a first manner and communicated to the tags the Q1 value. Upon receiving first replies from the tags as derived from communicating the Q1 value, a Q2 value for the Q parameter may be determined in a second manner that is different from the first manner and communicating to the tags the Q2 value.

Second replies may be received from the tags as derived from communicating the Q2 value. The first manner may include using a first algorithm and the second manner using a second algorithm that is different from the first algorithm.

In other embodiments, the first manner may include using a first subroutine of a computing algorithm, and the second manner may include using a second subroutine of the computing algorithm that is different from the first subroutine.

In further embodiments, the first manner may include using a computing algorithm subject to a first value of a damping parameter, and the second manner may include using the computing algorithm subject to a second value of the damping parameter that is different from the first value.

The second manner may be selected based on the Q1 value, the first contents, or a merit statistic that is determined from the first contents. In yet further embodiments, communicating the Q2 value may be prohibited until a preset number of first replies has been received.

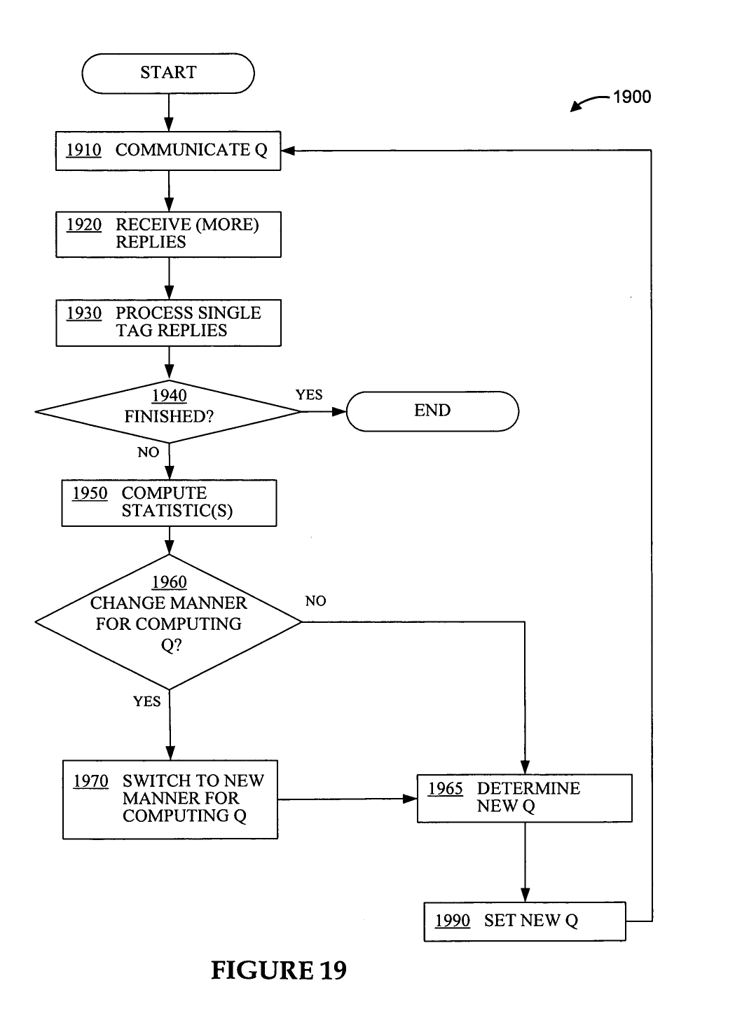

FIG. 19 is a flowchart illustrating a method for process 1900 that can be used to inventory tags by changing a manner of how a value of Q is determined, so that an overall performance can be optimized according to embodiments. Process 1900 may be implemented in an RFID reader such as RFID reader 120 of FIG. 1.

Process 1900 begins at block 1910, where the reader communicates with the tags. In one embodiment, the communication between the reader and the tags may involve an inventorying process, where the Q-parameter is modified based on an evaluation of tag responses by the reader. As part of addressing the tags, the reader may send a command such as a Query command that includes a Q value.

Block 1910 is followed by block 1920, where replies are received from tags and contents generated based on the received replies. As the inventorying process is performed with repeated exchanges between the reader and the tags, more replies may be received from the tags. Processing then proceeds to block 1930.

At block 1930, single replies are processed. As the reader receives single replies for slots, it may instruct the replying tags to set an inventory flag such that the inventoried tag remains silent for the rest of the process as others are inventoried. The reader may further access the inventoried tags for other purposes. Processing then proceeds to decision block 1940.

At decision block 1940, a determination is made whether all single replies are processed. If all single replies have been processed and all tags inventoried, inventorying process is completed and processing moves to a calling process for further actions.

If the determination at decision block 1940 is negative, processing advances to block 1950, where one or more statistics are computed. The computed statistic(s) may be used to determine whether to change the manner of computing Q based on the tag replies.

Block 1950 is followed by decision block 1960, where a determination is made whether the manner of computing Q is to be changed. If the manner of computing Q is to be changed, processing proceeds to block 1970, otherwise processing moves to block 1965 without changing the manner of computing Q.

At block 1970, the reader switches to a new manner of computing Q. Processing moves from block 1970 to block 1965, where a new Q value is determined based on the received tag replies and the manner of computing Q. Block 1965 is followed by block 1990.

At block 1990, the new Q value, which may be increased or decreased from the previous Q value, is set. Processing then returns to block 1910, where the new Q value is communicated to the tags and the process is repeated.

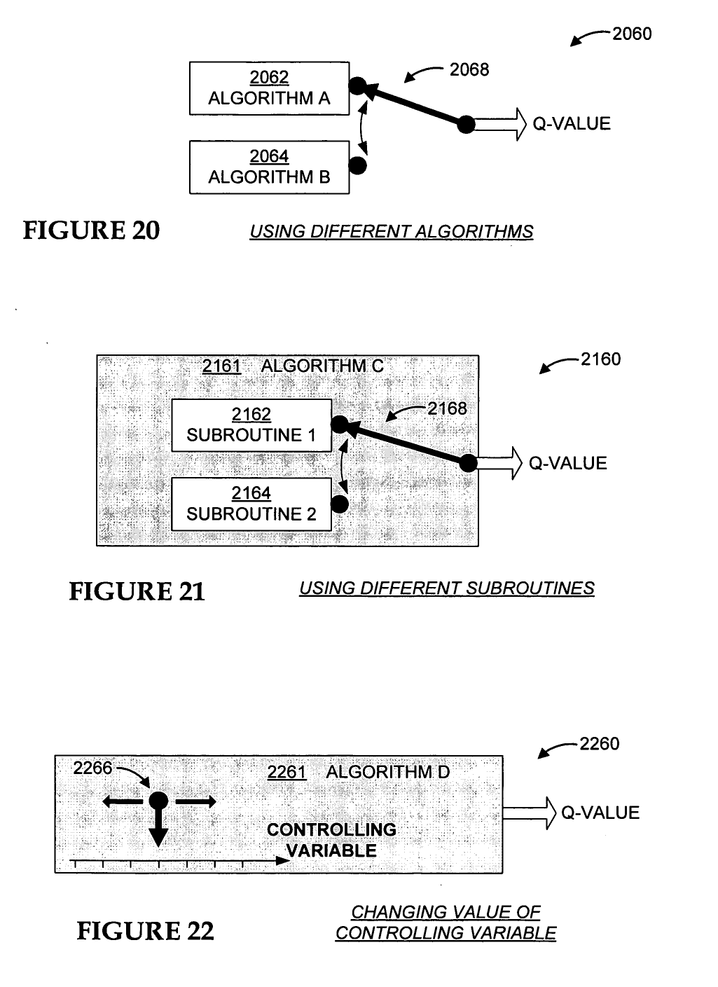

FIG. 20 is conceptual diagram 2060 illustrating the manner change of FIG. 19 being implemented by providing a choice between distinct algorithms, according to one embodiment.

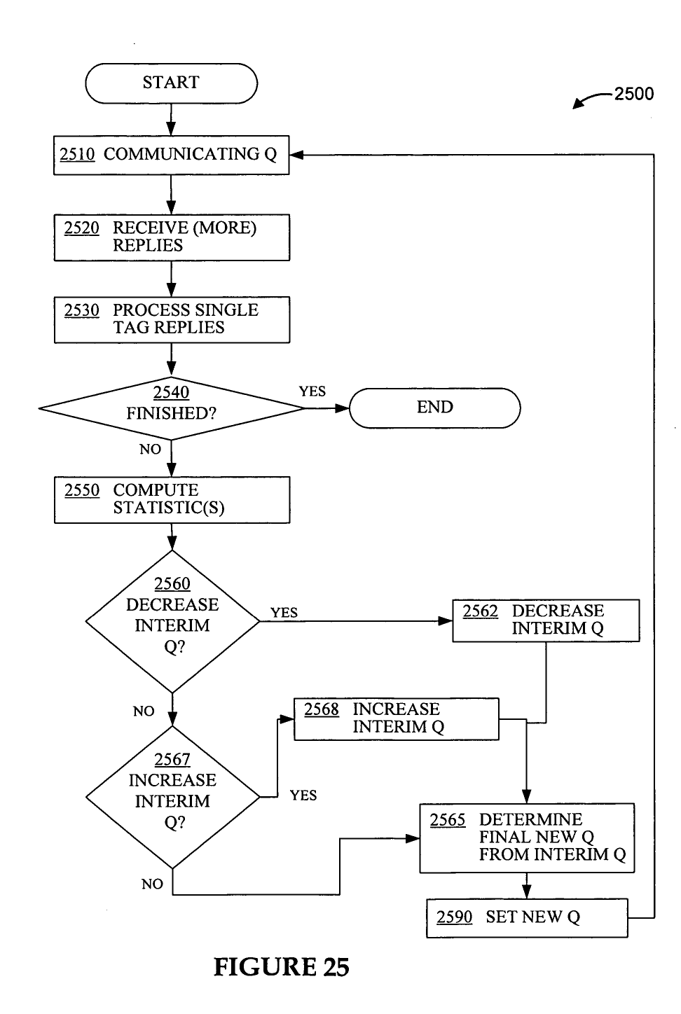

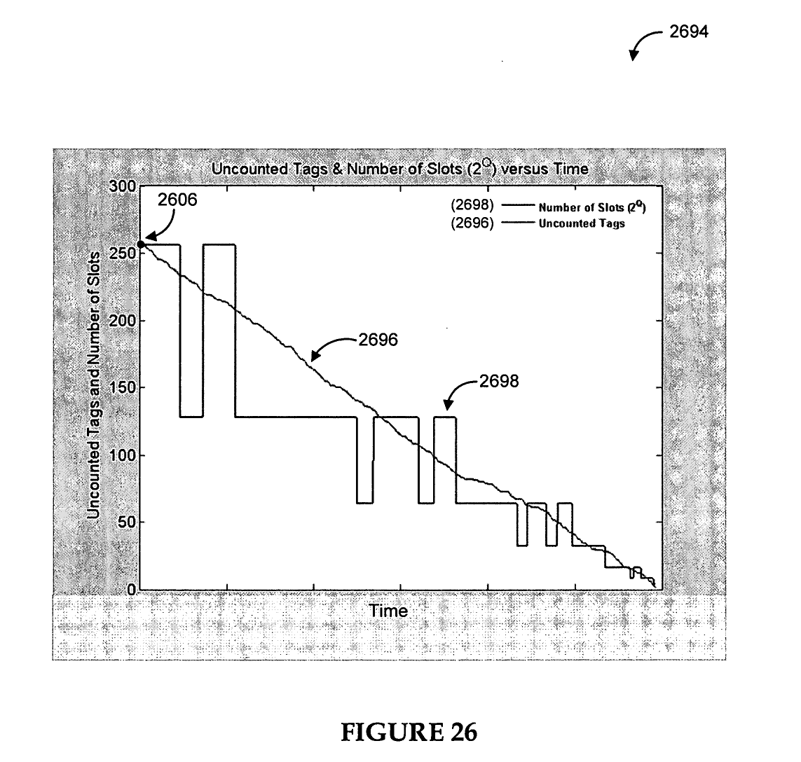

As shown in the figure, algorithm A (2062) and algorithm B (2064) can be used to determine Q. For example, algorithm A may be a heuristic convergence algorithm as described in conjunction with FIGS. 14-17 of this specification, and algorithm B may be an adaptive adjustment algorithm as described in conjunction with FIGS. 25 and 26 of this specification.

Switch 2068 represents a decision mechanism within the process of changing the manner for computing Q. As explained above, a reader inventorying a tag population may decide to change the manner of computing Q and select algorithm A or algorithm B at different points of the inventorying process.

FIG. 21 is conceptual diagram 2160 illustrating the manner change of FIG. 19 being implemented by providing a choice between distinct subroutines of an algorithm, according to another embodiment.

The process of changing subroutines occurs within a single algorithm such as algorithm C (2161). For example, algorithm C may be an adaptive adjustment algorithm as described in conjunction with FIGS. 25 and 26 of this specification. Algorithm C may include two different subroutines that determine how the interim Q value is to be incremented or decremented. Subroutine 1 (2162) may increment or decrement the floating point number of the interim Q value by single digits, while subroutine 2 (2164) may increment or decrement it by multiples of five for faster change.

Upon determining which subroutine is more appropriate for a particular stage of inventorying based on a number of factors such as change in Q, tag responses, and the like, the reader performing the inventorying may switch from one subroutine to the other as represented by switch 2168.

FIG. 22 is conceptual diagram 2260 illustrating the manner change of FIG. 19 being implemented by providing a choice of selecting a value of a controlling variable, according to a further embodiment.

According to this embodiment, a single algorithm is again used to determine a value for the Q-parameter. Algorithm D (2261) includes a controlling variable such as a damping parameter in a damping function. As depicted by switch 2266, the process of determining the Q value may be modified by changing a value of the controlling parameter (e.g. the damping parameter in the damping function).

As in the damping function example, the change of the controlling parameter may effect how rapidly a value of Q is to be changed or in what increments.

The example algorithms, subroutines, and controlling parameters provided herein are for illustration purposes only and do not constitute a limitation on the embodiments of the invention.

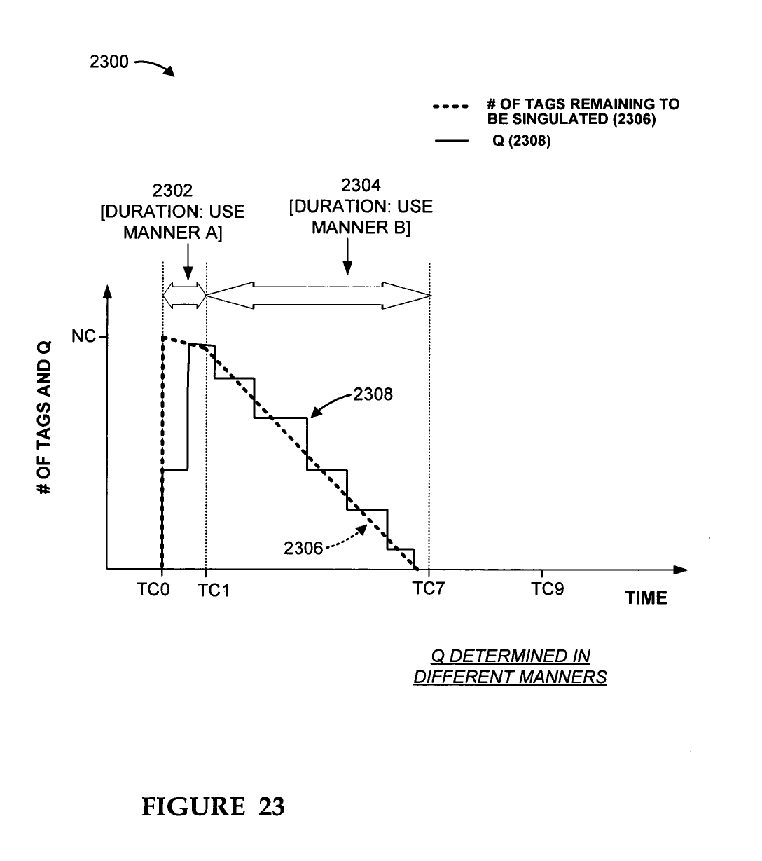

FIG. 23 includes diagram 2300 illustrating an optimization of Q using two different manners for determining Q.

Number of tags NC represented along the vertical axis could be initially unknown (time point TC0). This may happen during a power-up, when many tags are in an open state or when a subgroup is isolated from a larger group.

In example diagram 2300, the bold dashed line (2306) represents a change in Q values according to one method of determining Q throughout event C, where the reader is inventorying tags. As described before, Q is related to the number of slots. The other line (2308) shows the variation of Q according to another method of determining Q.

As diagram 2300 shows, slot-count parameter Q starts from a zero value and reaches an optimum initial value that corresponds to NC during a first period (2302). First period 2302 is defined by start and end time points TC0 and TC1, respectively.

According to the first method Q starts from a known previous value that corresponds to NC and arrives at a good starting value for Q (Qgsv) using manner A. According to the second method, Q starts at zero value and rapidly arrives at Qgsv with a fast convergence algorithm.

At time point TC1, both methods switch to manner B, which is employed throughout the second duration (2304). In this period, both methods decrease Q monotonically arriving at zero value around time point TC7, where all tags are inventoried.

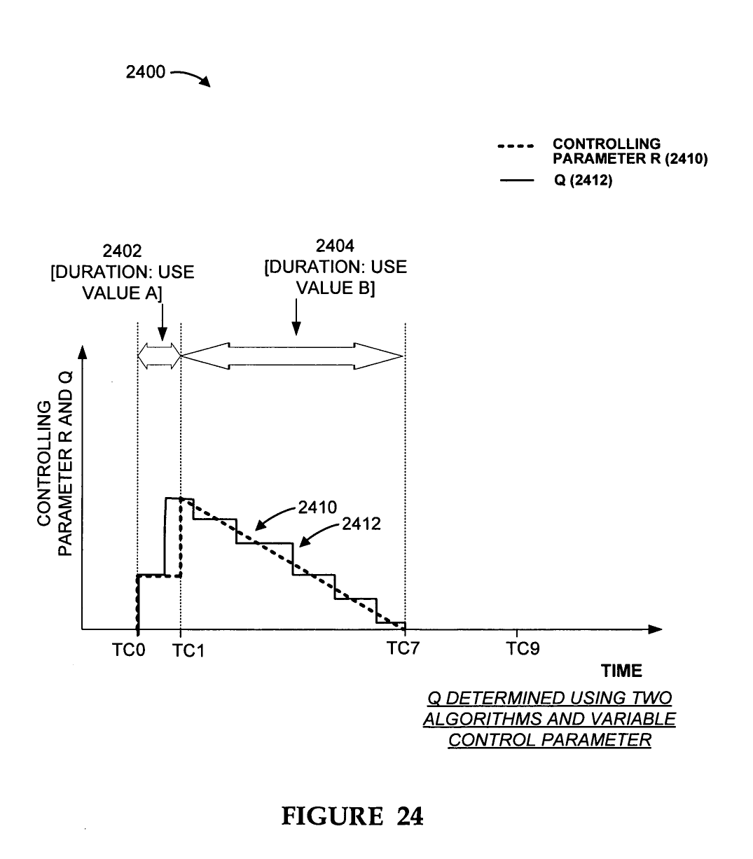

FIG. 24 includes diagram 2400 illustrating an example optimization of Q using two distinctly damping parameter values with a damping algorithm.

As diagram 2400 shows, damping parameter value A is used during the first duration (2402) defined by start and end time points TC0 and TC1, respectively. Algorithm A increases Q value in abrupt increments to an optimum initial value that may correspond to the number of uncounted tags.

At TC1, the second duration (2404) begins, where a second damping parameter value B, which is different from value A, is used. In this example diagram, damping parameter value B reduces Q monotonically as more tags are inventoried and the number of slots for uncounted tags decreases.

At TC7, before the end point of the second duration TC9, Q decreases to a zero value and all tags are inventoried.

Embodiments of the present invention described herein, in conjunction with FIGS. 19 through 24, may be practiced in various combinations with embodiments of inventions described in conjunction with other figures and in related applications referenced at the beginning of this document.

In one embodiment, a method for adaptively adjusting Q may begin by determining an interim value for the Q parameter and generating a Q1 value by applying the interim value to a damping function. The method may further include communicating the Q1 value for the Q parameter to at least a portion of the tags, and generating first contents based on received first replies from the tags derived from communicating the Q1 value. Then, a determination may be made whether to decrease the interim value depending on the first contents.

If the interim value is to be decreased, a Q2 value may be generated by applying a decreased interim value to the damping function, and the Q2 value for the Q parameter may be communicated to at least a portion of the tags. Second replies may be received from the tags as derived from communicating the Q2 value.

If the interim value is not to be decreased, it may be increased followed by generating a Q3 value by applying the increased interim value to the damping function and communicating the Q3 value for the Q parameter to at least a portion of the tags.

In another embodiment, increasing and/or decreasing the interim value may be performed by incrementing and/or decrementing the interim value, respectively. The increment value may or may not be equal to the decrement value.

In a further embodiment, the interim value may be a floating point number, and the damping function may return an integer by rounding the floating point number.

In other embodiments, communicating the Q2 value may be prohibited until a preset number of first contents has been generated, or one of the interim value and the Q2 value prevented from becoming less than a threshold.

In further embodiments, the decrement may be adapted directly or as a function of one of the interim value and the Q1 value. In embodiments where the interim value is to be incremented, one of the interim value and the Q3 value may be prevented from becoming larger than a threshold, and the increment may be adapted directly or as a function of one of the interim value and the Q1 value.

FIG. 25 is a flowchart illustrating process 2500 for a method of adaptively adjusting the Q-parameter. Process 2500 may be implemented in an RFID reader such as RFID reader 120 of FIG. 1.

Process 2500 begins at block 2510, where the reader communicates a Q value to the tags. Block 2510 is followed by block 2520, where replies are received from tags and contents generated based on the replies. As the inventorying process is performed with repeated exchanges between the reader and the tags, more replies may be received from the tags. Processing proceeds to block 2530.

At block 2530, single replies are processed. As the reader receives single replies for slots, it may instruct the replying tags to set an inventory flag such that the inventoried tag remains silent for the rest of the process as others are inventoried. The reader may further access the inventoried tags for other purposes. Processing proceeds to decision block 2540.

At decision block 2540, a determination is made whether all single replies are processed. If all single replies have been processed and all tags inventoried, inventorying process is completed and processing moves to a calling process for further actions.

If the determination at decision block 2540 is negative, processing advances to block 2550, where one or more statistics are computed. The computed statistic(s) may be used to determine whether to change the manner of computing Q based on the tag replies.

Block 2550 is followed by decision block 2560, where a determination is made whether to decrease the interim Q value. If the decision is affirmative, processing proceeds to block 2562, otherwise processing moves to decision block 2567, where another determination is made whether to increase the interim Q value.

At block 2562 the interim Q value is decreased. The decrease may be by a decrement or otherwise. In one embodiment, the interim Q value may include a floating point number, which is decreased by a predetermined decrement. In another embodiment, the decrease may be adapted directly or based on one of the interim Q value and the initial Q value. Processing moves from block 2562 to block 2565.

At decision block 2567, a determination is made whether to increase the interim Q value. If the decision is affirmative, processing proceeds to block 2568, otherwise processing moves to decision block 2565.

At block 2568, the interim Q value is increased. The increase may be by an increment or otherwise. Similar to the decrease, the increase may be based on incrementing the floating point number of the interim Q value. The increase may also be adapted directly or based on one of the interim Q value and the initial Q value. Processing moves from block 2568 to block 2565.

At block 2565, the final new Q value is determined from the interim Q value. The new Q value may be determined by applying a damping function to the interim Q value. For example, where the interim Q value includes a floating point number, the damping function may return an integer by rounding the floating point number. Processing advances from block 2565 to block 2590 where the new Q value, which may be increased or decreased from the previous Q value, is set.

Processing returns from block 2590 to block 2510, where the new Q value is communicated to the tags and the inventorying process is continued.

FIG. 26 is an example simulation diagram (2694) illustrating converging of Q, where Q is adaptively adjusted.

A number of uncounted tags and slots is represented along the vertical axis. The horizontal axis represents time for a comparison of remaining uncounted tags against time. The number of uncounted tags is about 256 in this example diagram (2606) corresponding to Q=8.

In example time diagram 2694, the monotonically declining line (2696) is the number of uncounted tags. The other line (2698) shows the variation of slots. The number of slots may be expressed in terms of Q as 2^{Q}.

As timing diagram 2694 shows, number of slots starts from a good starting value at 2606 and decreases adaptively as the number of uncounted tags declines. When all tags are counted, the number of slots reaches also zero value. The almost linear decrease in the number of uncounted tags without excessive variations in the number of slots, indicates a superiority of the adaptive adjustment method over other methods.

Embodiments of the present invention described herein, in conjunction with FIGS. 25 and 26, may be practiced in various combinations with embodiments of inventions described in conjunction with other figures and in related applications referenced at the beginning of this document.

In one embodiment, a method for an RFID reader includes communicating to a first plurality of RFID tags Q values for the Q parameter, where each of the tags chooses randomly one of a plurality of slots in response to each one of the communicated Q values and replies according to its chosen slot, and evaluating first replies received from tags belonging to the first plurality of tags. A first parameter is determined from evaluating the first replies and stored.

The first parameter is later retrieved and a value Q2 for the Q-parameter is determined from the first parameter. The reader then communicates to a second plurality of RFID tags the value Q2 for the Q parameter. The second plurality of tags may be distinct from the first plurality of tags.

In another embodiment, the first parameter may be stored in at least one of: the RFID reader, another device, and an RFID tag associated with the first plurality of RFID tags.

In a further embodiment, the first parameter may be the value Q2. The first parameter may be determined from a total number of tags belonging in the first plurality of tags, or it may also be determined from a user input.

In some embodiments, the reader may evaluate second replies received from the tags in the second plurality of tags, determine a second parameter from evaluating the second replies, and store the second parameter.

The second parameter may be stored such that it replaces the first parameter. The second parameter may also be determined from the first parameter.

An RFID reader, according to embodiments, may store at least one of the first and the second parameter in a memory.

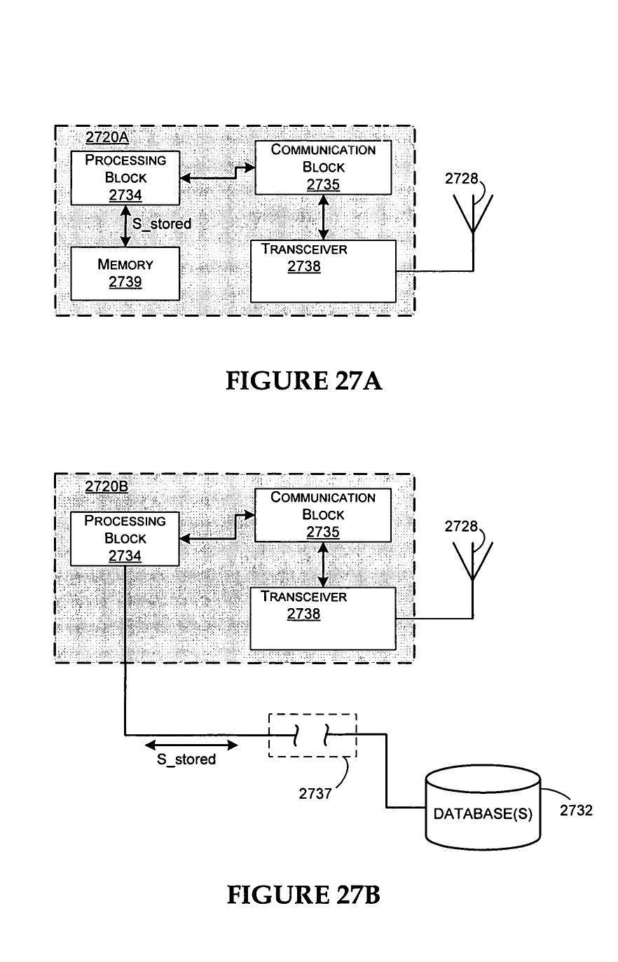

FIG. 27A illustrates major functional blocks of RFID reader 2720A, which is one possible embodiment of the RFID reader 120 of FIG. 1. Parts of RFID reader 2720A that are similarly numbered in RFID reader 520A of FIG. 5A are arranged to function in a likewise manner.

RFID reader 2720A is typically coupled to an antenna, such as antenna 2728, and includes major functional blocks: processing block 2734, communication block 2735, memory 2739, and transceiver 2738.

RFID reader 2720A, differently from RFID reader 520A, includes memory 2739. In one embodiment, RFID reader 2720A may employ a Q-parameter for inventorying tags within its field of view as described herein. An initial value of the Q-parameter may be determined in a variety of ways, and the value of the Q-parameter modified during the inventorying process.

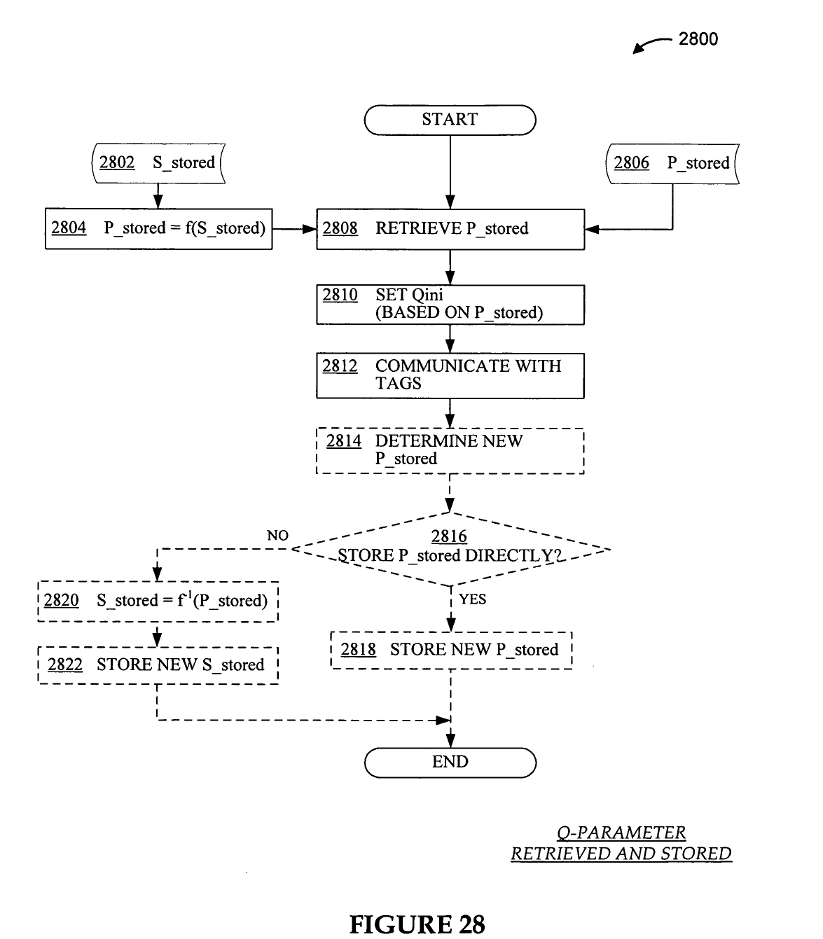

As explained in more detail below, in conjunction with FIG. 28, the initial value of the Q-parameter, Qini, may be determined from a stored value (S_stored). Memory 2739 may be employed to store S-stored.

At the beginning of the inventorying process, processing block 2734 may retrieve S_stored from memory 2739 and determined Qini based on S_stored. When a new value for the Q-parameter is determined at a predetermined point in the inventorying process (e.g. when all tags have been inventoried), processing block 2734 may determine a new value for S_stored based on the current value of the Q-parameter and store S_stored in memory 2739.

Memory 2739 may be implemented in any way known in the art. Moreover, memory 2739 may be an integrated part of processing block, an independent component within RFID reader 2720A, integrated with another component within RFID reader 2720A, and the like.

While memory 2739 is shown in the figure as a storage medium, the term “memory” is not used in a limiting fashion. In fact, values of S_stored, Q-parameter, and others may be stored in any type of storage known in the art. Such storage media may include, but are not limited to, random access memory, flash memory, hard drives, removable storage media, and the like. Another example of storage, a database, is described below in conjunction with FIG. 27B.

As in RFID reader 520A, RFID reader 2720A may include fewer or additional functional blocks and components to implement them.

FIG. 27B illustrates major functional blocks of RFID reader 2720B, which is another possible embodiment of the RFID reader 120 of FIG. 1. Parts of RFID reader 2720B that are similarly numbered in RFID reader 2720A of FIG. 27A are arranged to function in a likewise manner.

RFID reader 2720B, differently from RFID reader 2720A, does not include an integrated memory block. Instead, RFID reader 2720B communicates with database 2732 via communication link 2737 to store and retrieve S_stored.

Communication link 2737 may include any type of connection known in the art such as a phone line link, an Ethernet link, an RF link, an infrared link, and the like.

FIG. 28 is a flowchart illustrating process 2800 for an embodiment of a method of using an initial value of Q based on a previously stored parameter. Process 2800 may be implemented in an RFID reader such as RFID reader 2720A of FIG. 27A.

Process 2800 begins at block 2808, where parameter P_stored is retrieved. P_stored may be alternatively retrieved from a storage medium as shown in block 2806 or through a computation process as shown in block 2804. At block 2804, P_stored is computed from a stored parameter S_stored as shown in block 2802. Thus, P_stored may be a function of S_stored. P_stored and S_stored may be retrieved from a storage medium such as memory 2739 of FIG. 27A. Processing moves from block 2808 to block 2810.

At block 2810, an initial value, Qini, is determined for the Q-parameter based on P_stored. Qini may be determined based on a computation, one of the methods described in related applications referenced at the beginning of this specification, or a combination of those.

Block 2810 is followed by block 2812, where the reader addresses the tags using Qini. In one embodiment, the communication between the reader and the tags may involve an inventorying process, where the Q-parameter is modified based on an evaluation of tag responses by the reader. Next, processing moves to a group of optional blocks that describe a process of storing a new value for P_stored.

At optional block 2814, which follows block 2812, a new P_stored is determined. In one embodiment, the new P_stored may be determined based on a current value of the Q-parameter. In other embodiments, the new P_stored may be determined by other means such as user input, input from an automated system, historic average computation, and the like. The new P_stored may also be determined based on one population of tags and later used to inventory another population of tags, where the two populations may be different. Next, processing moves to optional decision block 2816.

At optional decision block 2816, a determination is made whether P_stored is to be stored directly. A reader may store S_stored based on the new value of P_stored instead of directly storing P_stored.

If the decision at optional decision block 2816 is affirmative, processing advances to optional block 2818, where the new value of P_stored is stored in the reader, in a remote storage device such as database 2732 of FIG. 27B, in one of the tags of the tag population, and the like.

If P_stored is not to be stored directly, processing moves to optional block 2820. At optional block 2820, a new value for S_stored is determined based on the new value of P_stored (i.e. S_stored is an inverse function of P_stored).

Optional block 2820 is followed by optional block 2822, where the new value of S_stored is stored by the reader.

Following optional blocks 2818 and 2822, the process is completed and processing moves to a calling process for further actions.

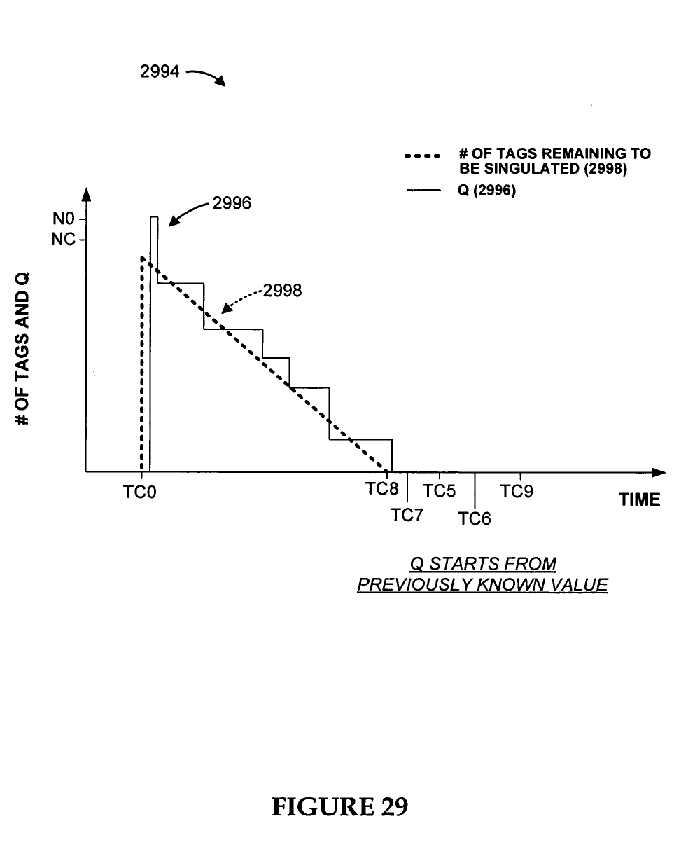

FIG. 29 includes example simulation diagram 2994 illustrating converging of Q, where Q starts from a known value.

Number of tags NC represented along the vertical axis could be initially unknown (time point TC0). This may happen during a power-up, when many tags are in an open state or when a subgroup is isolated from a larger group (the latter can occur when a Select command is used).

In example time diagram 2994, the monotonically declining line (2998) is the number of uncounted tags, here the addressed number of tags. The other line (2996) shows the variation of a Query command slot-count parameter Q, which is used for inventorying.

As timing diagram 2994 shows, slot-count parameter Q starts from a previously known value that corresponds to initial number of tags NO and decreases incrementally until all tags are inventoried at time point TC8, which is before the end time point TC9 for event C.

Embodiments of the present invention described herein, in conjunction with FIGS. 27A, 27B, 28, and 29, may be practiced in various combinations with embodiments of inventions described in conjunction with other figures and in related applications referenced at the beginning of this document.

This specification, examples and data provide a complete description of the manufacture and use of the composition of the invention. Since many embodiments of the invention can be made without departing from the spirit and scope of the invention, the invention resides in the claims hereinafter appended.

What is claimed is:

1. An RFID reader to communicate with a plurality of RFID tags, each of which can choose randomly one of a plurality of slots in response to a communicated value of a Q parameter and reply according to its chosen slot, the reader comprising:
a transceiver arranged to transmit and receive a modulated wave; and
a processing block arranged to:
determine an interim value for the Q parameter;
generate a Q1 value by applying the interim value to a damping function;
communicate to at least a portion of the tags the Q1 value for the Q parameter;
receive first replies from the tags as derived from communicating the Q1 value;
generate first contents from the first replies;
determine whether to decrease the interim value depending on the first contents; and
if so, decrease the interim value;
generate a Q2 value by applying the decreased interim value to the damping function; and
communicate to at least a portion of the tags the Q2 value for the Q parameter; and
receive second replies from the tags as derived from communicating the Q2 value.

2. The RFID reader of claim 1, wherein
the interim value is a floating point number, and
the damping function returns an integer by rounding the floating point number.

3. The RFID reader of claim 1, wherein the processing block is further arranged to:
prohibit communicating the Q2 value until a preset number of first replies has been received.

4. The RFID reader of claim 1, wherein the processing block is further arranged to:
prevent one of the interim value and the Q2 value from becoming less than a threshold.

5. The RFID reader of claim 1, wherein the processing block is further arranged to:
decrease the interim value by subtracting a decrement from the interim value.

6. The RFID reader of claim 5, wherein the processing block is further arranged to:
adapt the decrement.

7. The RFID reader of claim 5, wherein the processing block is further arranged to:
adapt the decrement as a function of one of the interim value and the Q1 value.

8. The RFID reader of claim 1, wherein the processing block is further arranged to:
determine whether to increase the interim value, and if so:
increase the interim value;
generate a Q3 value by applying the increased interim value to the damping function; and
communicate to at least a portion of the tags the Q3 value for the Q parameter; and
receive third replies from the tags as derived from communicating the Q3 value.

9. The RFID reader of claim 8, wherein the processing block is further arranged to:
prevent one of the interim value and the Q3 value from becoming larger than a threshold.

10. The RFID reader of claim 8, wherein the processing block is further arranged to:
increase the interim value by adding an increment to the interim value.

11. The RFID reader of claim 10, wherein the processing block is further arranged to:
adapt the increment.

12. The RFID reader of claim 10, wherein the processing block is further arranged to:
adapt the increment as a function of one of the interim value and the Q1 value.

13. The RFID reader of claim 8, wherein the processing block is further arranged to:
decrease the interim value by subtracting a decrement from the interim value, and wherein the increment equals the decrement.

14. An RFID reader to communicate with a plurality of RFID tags, each of which can choose randomly one of a plurality of slots in response to a communicated value of a Q parameter and reply according to its chosen slot, the reader comprising:
a means for determining an interim value for the Q parameter;
a means for generating a Q1 value by applying the interim value to a damping function;
a means for communicating to at least a portion of the tags the Q1 value for the Q parameter;
a means for receiving first replies from the tags as derived from communicating the Q1 value;
a means for generating first contents from the first replies;
a means for determining whether to decrease the interim value depending on the first contents; and if so:
a means for decreasing the interim value;
a means for generating a Q2 value by applying the decreased interim value to the damping function;
a means for communicating to at least a portion of the tags the Q2 value for the Q parameter; and
a means for receiving second replies from the tags as derived from communicating the Q2 value.

15. The RFID reader of claim XDSR1, further comprising:
a means for determining whether to increase the interim value, and if so:
a means for increasing the interim value;
a means for generating a Q3 value by applying the increased interim value to the damping function;
a means for communicating to at least a portion of the tags the Q3 value for the Q parameter; and
a means for receiving third replies from the tags as derived from communicating the Q3 value.

16. The RFID reader of claim 15, further comprising:
a means for adapting at least one of a decrement and an increment, wherein
decreasing the interim value includes subtracting a decrement from the interim value; and
increasing the interim value includes adding an increment to the interim value.

17. The RFID reader of claim 16, further comprising:
a means for adapting at least one of the decrement and the increment as a function of one of the interim value and the Q1 value.

18. A computer-readable medium having computer instructions for communicating with a plurality of RFID tags, each of which can choose randomly one of a plurality of slots in response to a communicated value of a Q parameter and reply according to its chosen slot, the instructions comprising:
determining an interim value for the Q parameter;
generating a Q1 value by applying the interim value to a damping function;
communicating to at least a portion of the tags the Q1 value for the Q parameter;
receiving first replies from the tags as derived from communicating the Q1 value;
generating first contents from the first replies;
determining whether to decrease the interim value depending on the first contents; and if so:
decreasing the interim value;
generating a Q2 value by applying the decreased interim value to the damping function;
communicating to at least a portion of the tags the Q2 value for the Q parameter; and
receiving second replies from the tags as derived from communicating the Q2 value.

19. The computer-readable medium of claim 18, wherein the instructions further include:
determining whether to increase the interim value, and if so:
increasing the interim value;
generating a Q3 value by applying the increased interim value to the damping function;
communicating to at least a portion of the tags the Q3 value for the Q parameter; and
receiving third replies from the tags as derived from communicating the Q3 value.

20. The computer-readable medium of claim 19, wherein the instructions further include adapting at least one of a decrement and an increment, and wherein
decreasing the interim value includes subtracting a decrement from the interim value; and
increasing the interim value includes adding an increment to the interim value.

21. The computer-readable medium of claim 20, wherein the instructions further include adapting at least one of the decrement and the increment as a function of one of the interim value and the Q1 value.

22. The computer-readable medium of claim 18, wherein
the interim value is a floating point number, and
the damping function returns an integer by rounding the floating point number.

23. A method for an RFID reader to communicate with a plurality of RFID tags, each of which can choose randomly one of a plurality of slots in response to a communicated value of a Q parameter and reply according to its chosen slot, the method comprising:
determining an interim value for the Q parameter;
generating a Q1 value by applying the interim value to a damping function;
communicating to at least a portion of the tags the Q1 value for the Q parameter;
receiving first replies from the tags as derived from communicating the Q1 value;
generating first contents from the first replies;
determining whether to decrease the interim value depending on the first contents; and if so:
decreasing the interim value;
generating a Q2 value by applying the decreased interim value to the damping function;
communicating to at least a portion of the tags the Q2 value for the Q parameter; and
receiving second replies from the tags as derived from communicating the Q2 value.

24. The method of claim 23, wherein
the interim value is a floating point number, and
the damping function returns an integer by rounding the floating point number.

25. The method of claim 23, further comprising:
prohibiting communicating the Q2 value until a preset number of first replies has been received.

26. The method of claim 23, wherein
one of the interim value and the Q2 value is prevented from becoming less than a threshold.

27. The method of claim 23, wherein
decreasing the interim value includes subtracting a decrement from the interim value.

28. The method of claim 27, further comprising:
adapting the decrement.

29. The method of claim 27, further comprising:
adapting the decrement as a function of one of the interim value and the Q1 value.

30. The method of claim 23, further comprising:
determining whether to increase the interim value, and if so:
increasing the interim value;
generating a Q3 value by applying the increased interim value to the damping function;
communicating to at least a portion of the tags the Q3 value for the Q parameter; and
receiving third replies from the tags as derived from communicating the Q3 value.

31. The method of claim 30, wherein
one of the interim value and the Q3 value is prevented from becoming larger than a threshold.

32. The method of claim 30, wherein
increasing the interim value includes adding an increment to the interim value.
The method of claim XDMR4, further comprising:
adapting the increment.

33. The method of claim 32, further comprising:
adapting the increment as a function of one of the interim value and the Q1 value.

34. The method of claim 32, wherein
decreasing the interim value includes subtracting a decrement from the interim value, and
the increment equals the decrement.
